(19) United States
(12) Patent Application Publication
(10) Pub. No.: US 2018/0299284 A1
(43) Pub. Date: Oct. 18, 2018

(54) Method and System For Avoidance of Accidents

(71) Applicant: Kevin Sunlin Wang, Flushing, NY (US)

(72) Inventor: Kevin Sunlin Wang, Flushing, NY (US)

(21) Appl. No.: 16/012,548

(22) Filed: Jun. 19, 2018

Related U.S. Application Data
(63) Continuation-in-part of application No. 14/885,999, filed on Oct. 17, 2015, now Pat. No. 10,024,684.
(60) Provisional application No. 62/236,666, filed on Oct. 2, 2015.
(60) Provisional application No. 62/150,118, filed on Apr. 20, 2015.
(60) Provisional application No. 62/113,922, filed on Feb. 9, 2015.
(60) Provisional application No. 62/092,100, filed on Dec. 15, 2014.
(60) Provisional application No. 62/086,560, filed on Dec. 2, 2014.

(51) Int. Cl. G01C 21/34; G08G 1/01

(52) U.S. Cl. CPC G01C 21/3492; G08G 1/0141

(57) ABSTRACT

Provided is a system for alerting users to help them avoid or prevent traffic accidents by mapping and storing traffic accident relevant data so as to alert a user in order to avoid potential accidents based on location and user type. User type may be a vehicle user, motorcyclist, bicyclist or pedestrian. Traffic accident relevant data comprises at least one of vehicle type data, motorcyclist type data, bicyclist type data, or pedestrian type data. Data corresponding to at least one relevant user type is retrieved and conveyed through notifications or customizable notifications based on user preference. Accuracy and validity of notifications is maintained by integrating user engagement panels for collection of information. The collected information is further subject to user ratings, where the database is updated or otherwise modified with the collected data that has been validated, and a reward may issue to users contributing valid traffic accident-related data.

### CROSS-REFERENCE TO RELATED APPLICATIONS

The present application is a continuation-in-part application of and claims priority to U.S. patent application Ser. No. 14/885,999, filed on Oct. 17, 2015, now U.S. Pat. No. ______, issued on ______, 2018, which is based on and claims priority to U.S. Provisional Application Ser. No. 62/236,666, filed on Oct. 2, 2015, U.S. Provisional Application Ser. No. 62/150,118, filed on Apr. 20, 2015, U.S. Provisional Application Ser. No. 62/113,922, filed on Feb. 9, 2015, U.S. Provisional Application Ser. No. 62/092,100, filed on Dec. 15, 2014, and U.S. Provisional Application Ser. No. 62/086,560, filed on Dec. 2, 2014, the entire contents of which are herein incorporated by reference.

### BACKGROUND

### Technical Field of Invention

The embodiments herein relate to an accident alert system and, more specifically, to a method and system for alerting users to help them avoid or prevent traffic accidents.

### Description of Related Art

To help stem the occurrence of fatal and non-fatal accidents, it is crucial to obtain accurate road-user information without having to wait for government action to provide tools to report and educate users about the avoidance of potential accidents. Currently, there are no mobile or web-based applications, or in-vehicle navigation systems that effectively inform the public so as to help reduce the potential for traffic accidents for various types of road users by getting them potentially life-saving information about possible dangerous locations or conditions. It is important for users to understand the reasons of accident involvement and how they relate to certain user types at certain locations, as well as have recommendations on how to take steps to avoid these accidents.

Therefore, there is a need for a system and method, utilizing various sets of accident related data or other data relating to potential dangers or hazards, to formulate, prepare and send notifications to educate and alert users about reasons for these accidents or to allow for precautionary measures such as recommendations on how to avoid such potential accidents when traveling through these hazardous locations, while not distracting the user with unnecessary notifications. Such a system could collect, analyze and determine the reason for these accidents, and make a user aware of areas of heightened potential risk. For example, in such a system, bicyclists could be notified to avoid areas having a history of a high number of bicycle accidents so that they may avoid these areas entirely or receive notifications from the system which alert them to the present dangers. Furthermore, data for specific locations could be analyzed for patterns based on a predetermined number of accidents defined by a user or by the system in an area as a whole (i.e., encompassing several locations). As discussed herein, the method and system according to the inventive disclosure overcomes many of the limitations and/or disadvantages of the prior art and provides a unique combination of attributes for assisting users to avoid potential accidents.

### SUMMARY OF THE INVENTION

This summary is not intended to identify or point to essential features or limit the scope of the subject matter claimed herein. The inventive disclosure generally relates to an accident alert system and, more specifically, to a system and method for alerting users to help them avoid accidents. In particular, the inventive disclosure establishes, a computer-implemented system and method for alerting a user to potentially dangerous locations or conditions in advance of the user arriving at those locations with the following objectives:

To provide a system for helping with the avoidance of potential traffic accidents.

To provide a way for, a user, using a remote computing device, to communicate with the accident avoidance system by way of a network (e.g., a wide-area network, a packet switched network, etc.), where the remote computing device comprises at least a location identifier, a clock mechanism, and a display apparatus.

To provide a way to organize traffic accident relevant data by categorizing it according to data type comprising vehicle relevant data, motorcyclist relevant data, bicyclist relevant data, or pedestrian relevant data.

To provide a system to receive user data comprising a present, identified, or designated location, a present, identified, or designated time, and a user type for the user, from the computing device and retrieve from the database traffic accident relevant data relevant to the user based on the user data from the database. Based on the retrieved traffic accident relevant data, the system can identify a location the user is approaching and generate a notification for the location, where the notification is based on the data type corresponding to at least a user type. The system may then transmit the notification to the remote computing device of the user.

To provide a method and system for predicting or inferring potential traffic accidents for a user at a location and alert the user of the potential traffic accidents, including but not limited to inferring a potential traffic accident for a user based on traffic accident related data, user data, and/or a particular user type.

To provide a database comprising historical traffic accident relevant data (i.e., including past or current data other than real-time data, which is publicly reported and obtained manually or automatically by the system from any number of private, government, educational, or other informational sources, or crowdsourced by other users), which is interactively correlated to crowdsourced traffic accident relevant data.

To provide a user engagement panel (“UEP”) for crowdsourcing traffic accident relevant data from users to collect such data related to avoiding a potential traffic accident at a dangerous location or where a traffic accident previously occurred. The UEP may include a display offering options to a user or divided into categories based on user type or accident type, and users may provide at least a portion of the crowdsourced traffic accident relevant data through the UEP, including but not limited to, reasons for a traffic accident for a location, and/or recommendations for avoidance of potential accidents for the location.

To help users be aware of and/or understand the causes or reasons for accidents by utilizing recommendations for how best to avoid potential accidents, and thereby help them learn to take appropriate preventive measures.

To provide notifications which include a reason for a traffic accident and/or a recommendation on how to avoid a potential traffic accident at the location. The recommendation may include a street view function to allow the user to see actual road conditions before the user approaches the location to familiarize the user with road conditions. The notification may be subject to ratings by additional users who receive the notification where at least part of the traffic accident relevant data in the database can be modified in response to a notification receiving a predetermined number of positive or negative ratings, at which point an award or reward can be allocated to users who shared the information or the reason and/or recommendation.

To keep data accurate and up-to-date, and to provide for ratings of the traffic accident related data or notifications by other users having firsthand experience, where firsthand experience is identified as having passed within a predetermined distance of the location and/or having received a notification regarding the location.

To provide a user type to avoid sending users excessive notifications unrelated to his/her user type, which may be categorized by a vehicle user type, a motorcyclist user type, a bicyclist user type, or a pedestrian user type. The present or designated time and location (or a time and location previously specified by the user) of a user may be cross-correlated, according to the user's user type, with the traffic accident relevant data in the database to predict a potential traffic accident at a location the user is approaching. A potential traffic accident can thus be predicted for the location where a traffic accident previously happened (e.g., where the accidents were within the same time frame of a day or in the same month of a year as the present or designated time).

To selectively generate and issue a notification to the user, where the notification includes a data type corresponding to at least one or a combination of user types, such as vehicle relevant data corresponding to at least a vehicle user type, motorcyclist relevant data corresponding to at least a motorcyclist user type, bicyclist relevant data corresponding to at least a bicyclist user type, pedestrian relevant data corresponding to at least a pedestrian user type, and other relevant data types corresponding to at least one or more other user types.

To enable a user to customize the setting for a predetermined distance to a location that the user is approaching so as to receive a notification. Other settings, such as a predetermined time before user reaches a location, may also be customized by the user.

To generate a notification including a comparison of parking and/or traffic rules for different locations with at least one prior accident to help the user avoid traffic accidents while outside the user's license jurisdiction. A notification can be generated based on the user's present location and the user's license jurisdiction, obtained from the user's driver license stored in the user's profile, where information obtained may include a country, state, or city of the license jurisdiction. The differences between the traffic rules and regulations of the user's licensed jurisdiction and those of the jurisdiction the user is presently in or wishes to travel to can be transmitted to the user when he/she approaches or comes within a predetermined distance of a location having a previous traffic accident or accidents in accordance with preset rules or configurations.

To provide a user with access to third-party application program interface(s) (API(s)) that provide, for example, weather related information to identify weather conditions that might affect driving conditions and potentially lead to a traffic accident if the user is driving through a location with prior traffic accident(s). A notification can be provided to the user as a reminder to perform vehicle maintenance and/or parts replacement or as an indicator of dangerous weather conditions based on weather related information.

To include a notification providing instructions on how to drive through a dangerous location, identifying an impact zone encompassing an area within a predetermined distance of a location having prior traffic accidents or notifying a user of a no-zone (i.e., a zone with limited or no visibility for commercial vehicles or non-commercial vehicles).

To provide notifications including route planning, which may suggest to the user a route to the intended destination with the least amount of potential traffic accidents.

The disclosed invention provides a computer-implemented system for providing traffic accident avoidance guidance. As disclosed, the system comprises a server communicatively coupled to one or more remote computing devices via a network, wherein the server includes at least one non-transitory computer-readable storage medium with computer-readable instructions stored therein, a database, and a processor for executing the computer-readable instructions to: receive, from a first remote computing device, traffic accident-related data pertaining to a location, wherein the data includes a reason for a traffic accident at the location or a recommendation for avoiding the traffic accident at the location; receive, from one or more remote additional user computing devices, one or more ratings of at least a portion of the traffic accident-related data; in response to receiving a predetermined number of the one or more ratings, update the traffic-accident related data in the database; receive, from a second remote user computing device, an input comprising the location and a designated time; identify at least the portion of traffic accident-related data that is updated in the database and associated with the location; and transmit to the second remote user computing device at least the portion of the traffic accident-related data associated with the location.

The disclosed invention also provides a computer-implemented system which generates a notification for the location based at least on the identified portion of the traffic accident related data, wherein the notification includes at least the portion of the traffic accident related data; transmit the notification to one or more additional users; receive, from the one or more remote additional user computing devices associated with the one or more additional users, one or more ratings of the notification; and in response to the notification receiving a predetermined number of positive or negative ratings, update the traffic accident data in the database. The one or more additional users may have firsthand experience with the location, and wherein the firsthand experience is determined based on whether (i) the notification associated with the location was received by the one or more additional users, or (ii) the one or more additional users were within a predetermined distance of the location. The one or more additional user remote computing devices may include one or more global positioning system (GPS) receivers configured to generate location data corresponding to one or more locations, and wherein the firsthand experience is determined by receiving the location data of a remote computing device corresponding to a particular location of a particular additional user. The GPS receiver may be located within a mobile device or a vehicle navigation system.

In still another embodiment, the processor further executes the computer-readable instructions to: predict a potential traffic accident at the location based on at least one of: (i) at least the portion of the traffic accident-related data retrieved from the database, (ii) a user type of the user, (iii) one or more traffic accidents having occurred at the location, or (iv) one or more traffic accidents having occurred at a location proximate to the location, where the traffic accident-related data is stored according to one or more data types comprising at least one of: commercial vehicle data type, non-commercial vehicle data type, data type based on vehicle, data type based on vehicle plate, motorcycle data type, bicycle data type, or pedestrian data type, and where the user type comprises at least one of: commercial vehicle user type, non-commercial vehicle user type, user type based on vehicle, user type based on vehicle plate, motorcyclist user type, or bicyclist user type. The location of the user and the designated time may be cross-correlated with the traffic accident related data associated with prior traffic accidents at the location to predict by inference a potential traffic accident at the location, and wherein the prior traffic accidents occurred during a time frame which includes the designated time, where the inference is based on at least one of: information relating to one or more vehicles involved in an accident at the location, or information relating to one or more individuals involved in an accident at the location, and wherein the information relating to the one or more individuals involved in the accident at the location comprises at least one of: age, gender, occupation, education, marital status, driving experience, driving history or record, driving vehicles, vehicle operator as a professional driver, travel properties, safety awareness, responsibility and attitude to life, emotional stability, environmental adaptability, adventurous, or psychological demeanor. Also, the processor may further execute the computer-readable instructions to, in response to the notification receiving a predetermined number of ratings, issue a reward to a contributor of at least a part of the reason or the recommendation.

The disclosed invention also provides a computer-implemented system for providing traffic accident avoidance guidance, comprising a server communicatively coupled to one or more remote computing devices via a network, wherein the server includes at least one non-transitory computer-readable storage medium with computer-readable instructions stored therein, a database, and a processor for executing the computer-readable instructions to: selectively retrieve, from the database, at least a portion of traffic accident-related data pertaining to a location, wherein the data includes a reason for a traffic accident at the location or a recommendation for avoiding the traffic accident at the location; selectively generate a notification for at least the portion of the traffic-accident related data associated with the location; transmit the notification to one or more additional user computing devices; receive, from the one or more additional users computing devices, one or more ratings of the notification; in response to receiving a predetermined number of the one or more ratings, update the traffic accident data in the database; receive, from a user computing device, an input comprising the location and a designated time; transmit to the user computing device at least a portion of the updated traffic accident-related data associated with the location.

The disclosed invention also provides a computer-implemented system for providing traffic accident avoidance guidance, the system comprising a server communicatively coupled to a remote computing device via a network, wherein the server includes at least one non-transitory computer-readable storage medium with computer-readable instructions stored therein, a database, and a processor for executing the computer-readable instructions to: receive, from a first remote computing device, traffic accident-related data pertaining to a location; display on a graphical user interface of a remote additional user computing device an engagement panel for an additional user to provide a rating of at least a portion of the traffic accident-related data associated with the location, wherein the additional user has firsthand experience with the location, and wherein the firsthand experience is determined based on one of: (i) a first notification, received by the additional user, for the location, or (ii) the additional user being within a predetermined distance of the location; in response to receiving the rating, update the traffic accident-related data stored in the database to include at least the portion of the traffic accident-related data subject to the rating; receive, from a second remote user computing device, an input of the second user comprising the location, a designated time, and a user type; identify potential traffic accident-related data associated with the location for the second user by precluding at least a portion of the traffic accident-related data based on at least one of: (i) the user type, or (ii) the portion of the traffic accident-related data relating to a location exceeding a predetermined distance from the location indicated by the second user input; and generate a second notification including the potential traffic accident-related data for the second user.

The disclosed invention also provides a computer-implemented system for providing traffic accident avoidance guidance, the system comprising a server communicatively coupled to one or more remote computing devices via a network, wherein the server includes a non-transitory computer-readable storage medium with computer-readable instructions stored therein, a database, and a processor for executing the computer-readable instructions to: receive traffic accident-related data pertaining to a location; display, via a user engagement panel of a remote computing device, at least a portion of the traffic accident-related data associated with the location; receive, from one or more users having firsthand experience with the location, one or more ratings of the portion of the traffic accident-related data displayed, wherein the one or more ratings are positive or negative, wherein the firsthand experience is determined based on the one or more users being within a predetermined distance from the location; and in response to the one or more positive ratings reaching a predetermined number: store at least the portion of the traffic accident-related data in the database; generate a notification based on at least the portion of the traffic-accident related data, wherein the notification comprises data in accordance with a user type; and transmit the notification to one of the one or more remote computing devices.

The disclosed invention also provides a computer-implemented system for providing traffic accident avoidance guidance, the system comprising a server communicatively coupled to one or more remote computing devices via a network, wherein the server includes at least one non-transitory computer-readable storage medium with computer-readable instructions stored therein, a database, and a processor for executing the computer-readable instructions to receive, from a first remote computing device, traffic accident-related data pertaining to a location, wherein the data includes a reason for a potential traffic accident at the location or a recommendation for avoiding the traffic accident at the location; receive, from one or more remote additional user computing devices, one or more ratings of at least a portion of the traffic accident-related data, wherein the one or more ratings are positive or negative; in response to receiving a predetermined number of the positive ratings or a predetermined number of the negative ratings, update the traffic-accident related data in the database; receive, from a second remote user computing device, an input comprising the location and a designated time; identify at least the portion of the traffic accident-related data that is updated in the database and associated with the location; and transmit to the second remote user computing device at least a portion of the updated traffic accident-related data associated with the location.

Other objects, features, and characteristics of the inventive disclosure, as well as the methods of operation and functions of the related structural elements, and the combination of parts and economies of manufacture and development, will become more apparent upon consideration of the following detailed description with reference to the accompanying drawings, all of which form a part of this specification.

### BRIEF DESCRIPTION OF THE DRAWINGS

A further understanding of the inventive disclosure can be obtained by reference to a preferred embodiment set forth in the illustrations in the accompanying drawings. Although the illustrated preferred embodiment is merely exemplary of methods, structures and compositions for carrying out the inventive disclosure, both the organization and method of the invention, in general, together with further objectives and advantages thereof, may be more easily understood by reference to the drawings in conjunction with the following description. The drawings are not intended to limit the scope of this invention, which is set forth with particularity in the claims as appended or as subsequently amended, but merely to clarify and exemplify the invention. Accordingly, a more complete appreciation of the present disclosure and many of the attendant aspects thereof will be readily obtained as the same becomes better understood by reference to the following detailed description when considered in connection with the accompanying drawings, wherein:

FIG. 1 illustrates a diagram of the system for mapping and storing traffic accidents and alerting a user of potential traffic accidents, according to an exemplary embodiment of the inventive disclosure;

FIG. 2 is a schematic diagram illustrating a preferred configuration of a computing device for enabling a user to interact with the computing system, in accordance with an exemplary embodiment of the inventive disclosure;

FIG. 3A-3B are schematic diagrams illustrating exemplary database structure, content, and organization, according to exemplary embodiments of the inventive disclosure;

FIG. 4A is a flowchart illustrating a method for mapping and storing traffic accidents and alerting users of potential traffic accidents, according to an exemplary embodiment of the inventive disclosure;

FIG. 4B is a flowchart illustrating a process for obtaining accident specific information, according to an exemplary embodiment of the inventive disclosure;

FIG. 5 is a flowchart illustrating a process for verifying crowdsourced data, according to an exemplary embodiment of the inventive disclosure;

FIG. 6 is a flowchart illustrating the workflow of an in-vehicle navigation system, according to an exemplary embodiment of the inventive disclosure;

FIG. 7 is a flowchart illustrating the workflow of a process by which the database is updated, according to an exemplary embodiment of the inventive disclosure;

FIG. 8A is a flowchart illustrating the workflow of a process by which a reward is issued based on positive ratings of a notification reaching a predetermined number, according to an exemplary embodiment of the inventive disclosure;

FIG. 8B is a flowchart illustrating the workflow of a process by which notifications and/or data in the database are updated based on the notification and/or data receiving a predetermined number of negative ratings, according to an exemplary embodiment of the inventive disclosure;

FIG. 9 shows an illustration depicting an exemplary display of a user's computing device displaying a UEP, in accordance with an exemplary embodiment of the inventive disclosure; and

FIG. 10 shows an illustration depicting a notification that a user may receive on the display of a remote computing device, depicted as a smartphone, in accordance with an exemplary embodiment of the inventive disclosure.

### DETAILED DESCRIPTION OF THE INVENTION

As required, a detailed illustrative embodiment of the inventive disclosure is provided herein. However, techniques, methods, systems, compositions and operating structures in accordance with the inventive disclosure may be embodied in a wide variety of sizes, shapes, forms and modes, some of which may be quite different from those in the disclosed embodiment. Consequently, the specific structural, functional and step-by-step details disclosed herein are merely representative, yet in that regard, they are deemed to afford the best embodiment for purposes of disclosure and to provide a basis for the claims herein which define the scope of the inventive disclosure.

In the following detailed description, specific embodiments that may be practiced are shown by way of illustration and explanation. The embodiments are described in sufficient detail to enable those skilled in the art to practice the embodiments, and it is to be understood that logical, mechanical, and other changes may be made without departing from the scope of the embodiments. The following detailed description is therefore not to be taken in a limiting sense. In describing exemplary embodiments of the inventive disclosure illustrated in the drawings, specific terminology is employed for the sake of clarity. However, the present disclosure is not intended to be limited to the specific terminology so selected, and it is to be understood that each specific element includes all technical equivalents which operate in a similar manner.

Exemplary embodiments described herein are merely illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims. In the description of the figures below, it is understood that the details described above may be combined with or may be used in place of similar attributes described below and that the figures are used only to illustrate a particular exemplary embodiment of the inventive disclosure. For the purpose of providing simplified figures that are easy to understand, many of the details described herein have been omitted from the figures. However, it is contemplated that the details described herein may be incorporated into the approach of the description below in any feasible manner.

The invention may assist a user in avoiding an accident by alerting the user of the potential danger through notifications based on accident data analyses and the user's current location. Notifications/alerts may be initiated by the system based on the stored data or may be triggered by manual or other input from a user and might contain not only just alerts but other background information (e.g., the reasons for the accident and recommendations on how to avoid accidents) from the historical accident data and/or crowdsourced data. While referenced as “reasons,” one of ordinary skill in the art will appreciate that in practice this phrase could be described in numerous ways, including, but not limited by terms or phrases such as “cause,” “explanation,” or any other similar terms (i.e., any term used to describe how an accident happened or occurred). One of ordinary skill in the art will appreciate that in practice, such “recommendation” can be, for example, a “suggestion,” “advice,” or the like, but regardless, is aimed at alerting a user on how to avoid one or more potential accidents at a designated location. “Real-time” is considered to be real-time when one or more users share data immediately, which can be within a predetermined period of time close to the present time, such as within fifteen minutes or five minutes, or it may be virtually instantaneous with the present time. If the data does not meet requirements to be considered real-time data. Alternatively, if data is not considered historical data as defined herein, then the data is considered to be real-time. Designated time is considered to be a time that is either selected by the system based on predetermined rules or received/input by a user of the system, and could represent a past, present, or future time. The term “user(s)” as used herein is intended to encompass not only driver(s), but other individuals such as motorcyclists, bicyclists, and/or pedestrians. As used herein, the terms cycle and bicycle or cyclist and bicyclist are deemed to have the same meaning and may be used interchangeably. The term “traffic collision,” also known as a “traffic accident,” “accident,” “road traffic collision,” “road traffic accident,” “wreck,” etc., may be used interchangeably. A vehicle accident occurs when a vehicle collides with another vehicle, pedestrian, motorcycle, bicycle, animal, road debris, etc.

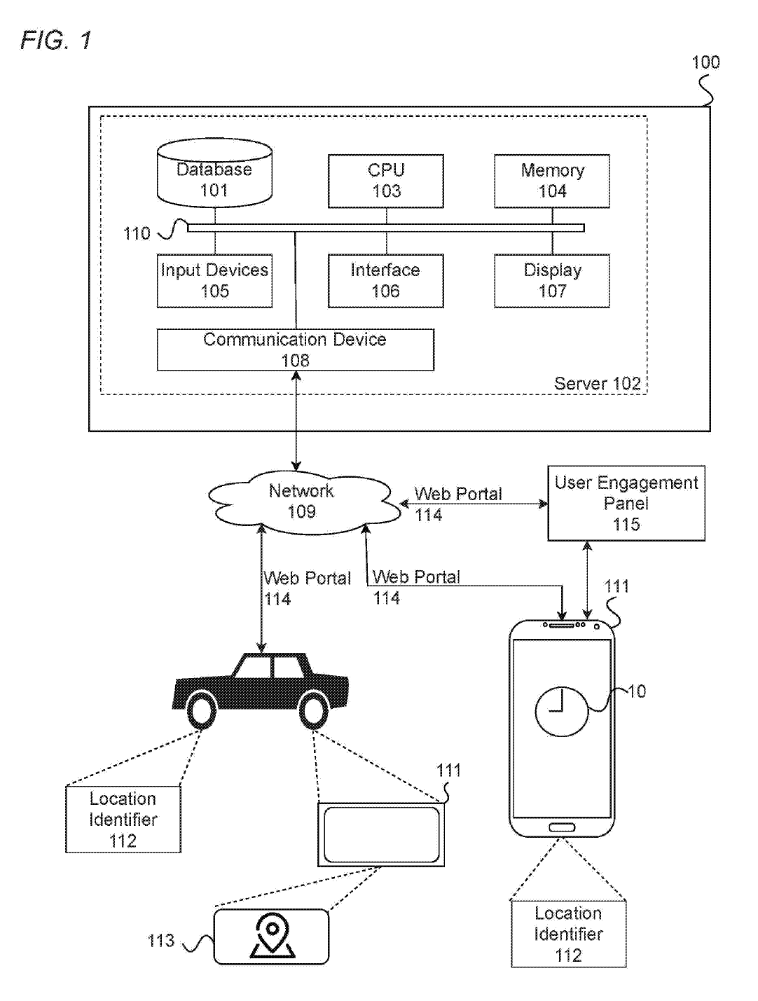

An exemplary embodiment of the inventive disclosure may also refer to the implementation of a system and method through a combination of hardware and software that operates on portable or mobile computing device 111, as depicted, for example, in FIGS. 1-2 and 9-10. Such mobile computing device 111 may comprise various pre-programmed or programmable features combined, integrated, or communicatively coupled with components including but not limited to one or more servers, databases, mobile end applications, web portals, network settings, etc. With the support of these components, information may be provided through user interfaces, such as websites, mobile applications, or in-vehicle navigation systems. In addition, there may be one or more servers that may be in a distributed architecture or structure with support from data centers that may be located anywhere around the world. These implementations may be communicatively linked and cross-platformed with an electronic map display of indicators which convey traffic accident related information, profile data, setting information, etc., so that a user, via computing device 111, may be provided with traffic accident relevant data for a specific location, a general location, or traffic safety generally.

It may be appreciated that computer program instructions of server 102 or computing device 111 may include computer executable code in any of a variety of languages, including, but not limited to, C, C#, C++, Java, JavaScript, Python, assembly language, Lisp, SQL, PHP, Ruby on Rails, IOS, Visual Basic .Net, Delphi/Object Pascal, Pearl, Swift, Go, R, MATLAB, Scratch, and so on. Such languages may include assembly languages, hardware description languages, database/functional/imperative programming languages, and so on. Computer program instructions can be stored, compiled, or interpreted to run on a computer, a programmable data processing apparatus, a heterogeneous combination of processors or processor architectures, and so on. In some embodiments, a computer enables execution of computer program instructions including multiple programs or threads, which may be processed more or less simultaneously to enhance utilization of the processor and to facilitate substantially simultaneous functions. By way of implementation, any and all methods, program codes, program instructions, and the like described herein may be implemented in one or more threads, which can spawn other threads that themselves have assigned priorities associated with them. A computer can process these threads based on priority or any other order based on instructions provided in the program code. Unless explicitly stated or otherwise clear from the context, “execute” and “process” are used interchangeably to mean execute, process, interpret, compile, assemble, link, load, any and all combinations of the foregoing or the like. Therefore, embodiments that execute or process computer program instructions, computer-executable code, or the like can suitably act upon the instructions or code in any and all of the ways just described.

The inventive disclosure may be described in the general context of computer-executable instructions, such as program modules, executed by a computer. Generally, program modules may include routines, programs, objects, components, data structures, etc., that perform particular tasks or implement particular data types. The computer program and data may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed hard disk), an optical memory device (e.g., a CD-ROM or DVD), a PC card (e.g., PCMCIA card), or other memory device. The computer program and data may be fixed in any form in a signal that is transmittable to a computer using any of various communication technologies, including, but in no way limited to, analog, digital, optical, wireless, networking, and internetworking technologies. The computer program and data may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over a network. It is to be appreciated that any of the software components of the inventive disclosure may, if desired, be implemented in ROM (read-only memory) format.

An exemplary embodiment of the inventive disclosure may be used by different user types, where “users” can be any of a variety of users, members of the general public, and/or computer systems, which include but are not limited to: professionals, civilians, vehicles, websites, robots, driverless or autonomous vehicles, in-vehicle systems, global positioning satellites (GPS), and/or other electronic systems, or used as a mobile application on computing device 111. The inventive disclosure may also be enlarged to encompass other systems or services that may process, utilize, and display the traffic accident related data (e.g., contributions to the field of information services for online mapping companies and GPS manufacturers, smartphone or mobile device manufacturers, wireless service providers, application creators and developers, mobile operating system developers and distributors, and automated vehicle systems such as self-driving vehicles, etc.).

The inventive disclosure may potentially be employed by self-driving/autonomous vehicle technology, where further developments can be affected through integration with a crash-avoidance system of an autonomous vehicle and may offer such an improvement by providing a computer-implemented system and method for avoidance of potential traffic accidents. The inventive disclosure may be integrated into, for example, existing hardware (i.e., external sensors and processors), and software which might be associated with an autonomous vehicle. Traffic accident notifications integrated with the automated vehicle's navigation system may help an autonomous vehicle avoid traffic accidents.

The inventive disclosure is designed to help reduce the number of accidents by analyzing dangerous areas and informing the users by various means (i.e., through pictures, videos, comments, suggestions, etc.) about the dangerous locations or conditions, the reasons causing accidents, and possible preventative measures that can be taken. Accidents may be caused by one factor or a multitude of factors, which may represent common patterns or relationships (e.g., through use of the statistical measures discuss herein) based on a predetermined number of accidents defined by a user or by the system, or an accident that happened in an isolated incident. In either case, knowledge of the causes of previous accidents may help prevent similar accidents in the future. Certain areas may be accident prone because of expectations from the parties involved (e.g., the driver or the pedestrian). For example, one or both parties may act proactively to avoid an accident and make assumptions which actually cause the accident. The assumption of each party may be that the other party will act in a safe manner to avoid a potential accident.

Referring first to FIG. 1, shown is a schematic diagram of the computer-implemented system according to an exemplary embodiment of the inventive disclosure for mapping and storing traffic accident information and data, and for alerting a user to the potential for traffic accidents in order to help them avoid or prevent such traffic accidents. As shown in FIG. 1, computing system 100 generally includes a combination of hardware and software operable in conjunction with, for example, an application running on remote computing device 111, which may be a handheld mobile device such as a smartphone or other internet-enabled cell phone, an in-vehicle navigation system, or another means of access such as a laptop computer, desktop computer, tablet, smartwatch, etc. Computing system 100 generally has one or more connections through a communication network (e.g., wireless wide-area network (WAN) 109 (e.g., the Internet)).

Computing system 100 may include server 102 comprising one or more hardware devices or software including database 101, one or more processors or central processing unit (CPU) 103, one or more server-readable program storage media or memory 104, input devices 105 (e.g., a keyboard, mouse, scanner, microphone, etc.), interface 106, display 107 (e.g., LED, OLED, or other computer monitor screen), and communication device 108. Program storage media (memory) 104 can be non-transitory and tangible in nature and may embody a program of instructions executable by processors 103 to search and update historical accident data for a geolocation to assist users in avoiding traffic accidents. The hardware devices within server 102 may all be connected or communicatively coupled by bus 110. Additionally, for convenience, aesthetics, etc., hardware devices described herein may be housed either inside or outside of server 102 or computing system 100 and connected via a wired or wireless link. Preferably, CPU 103 may be any type of logic processing unit, such as one or more digital signal processors, application-specific integrated circuits, etc., which may be connected through any known system bus structures, including a memory bus with memory controller, a peripheral bus, and a local bus to implement system functionalities.

Communication device 108 may include any approach for communicating data over one or more networks or to one or more peripheral or remote devices, and can include, but is not limited to, circuitry and control systems for providing wireless connections, wired connections, cellular connections, data port connections, Bluetooth® connections, or any combination thereof, using means that may include devices enabled to communicate using such communications approaches. One of ordinary skill in the art would appreciate that there are numerous approaches for communications that may be utilized in accordance with the inventive disclosure.

Preferably, remote computing device 111 may be a device which allows a user to interact with computing system 100 by providing an interactive display where the user can see notifications, input text, make voice commands, etc. Computing device 111 can include means for local computing such as a microprocessor and memory devices, and may be configured to support a camera, a microphone, a touch screen display, a clock mechanism 116, and other devices. If computing device 111 does not have a built-in display device, remote display device 113 may be utilized to output visual displays and/or audio. Optionally, various functions of computing device 111 can include but are not limited to a phone call function, GPS tracking for geolocation mapping (i.e., latitude and longitude coordinates), taking a video or photograph, etc.

Preferably, computing device 111 can connect to computing system 100, such that a notification can be formulated and transmitted to computing device 111 when relevant. Herein, “relevant” with respect to receiving a notification can mean that a user or computing device 111 is determined to be a certain distance from a location where one or more previous traffic accidents occurred, or a certain distance from some other dangerous locations even where no prior accidents had occurred, and/or that the content of the notification (e.g., the data on which it is based) is relevant to the user based on a predetermined criteria such as user type, vehicle type, and/or data type. A user can be provided with a visual and/or audio notification at such relevant time or location.

Computing device 111 and/or location identifier 112 can send location-based services (LBS) data to computing system 100 such that, when the correct conditions are met (e.g., the user approaches a potentially dangerous location or manually requests information), computing system 100 can query database 101 for relevant traffic accident related data stored in database 101. Based on a user type of the user (e.g., the user drives a Camry with non-commercial plates), which can be cross referenced with the location of the user (e.g., approximate address, geolocation, etc.) and the present or designated time (e.g., time of day, week, month, season, etc.), computing system 100 may identify relevant data for generating a notification (e.g., previous traffic accidents that relate to non-commercial vehicles), and tailor it according to the user's preferences (e.g., how the user wants to be notified, the predetermined distance from an intersection, how many times a notification repeats, etc.). Computing system 100 may periodically query the data in database 101, or alternatively, may access database 101 using specific APIs (e.g., by subscription) or by being fed this data as it is made available. Computing device 111 may connect to computing system 100 to relay data such as time, date, location, etc., receive a notification, and process and display that notification to the user.

The system and method may categorize user types into at least vehicle user type, motorcyclist user type, bicyclist user type, and pedestrian user type. System 100 can be used in various combinations by a plurality of users, singly by just one user type using data pertaining only to that user type, or with just one user type but utilizing additional portions of the traffic accident relevant data in addition to the data pertaining only to that user type. User type may further be categorized by commercial vehicle user type, non-commercial vehicle user type, vehicle user type based on type of plate, or vehicle user type based on type of vehicle. Vehicle user type may not necessarily be limited to one operated by a driver, but rather may be an autonomous vehicle. While referenced as “user type,” one of ordinary skill in the art will appreciate that in practice, this could be implemented in numerous embodiments, including but not limited to isolating one or a combination of user types.

Data retrieved from database 101 may be formatted by computing system 100 and transmitted as a notification and sent to computing device 111 through communication device 108. To generate a notification, computing system 100 may query different data sets within database 101, for example, historical traffic accident information, the user's present, identified or designated location, the present, identified or designated time, administrative notices or temporary notices applicable to the user type of that user, etc. Furthermore, computing system 100 can search for weather related information (i.e., where weather patterns or conditions could have an effect on the users' traffic safety).

Notifications specific to a commercial vehicle might include specifically relevant information for commercial vehicle users. Alternatively, the information contained within a notification can be based on specific data from the combination of data for commercial vehicles, as the notification may be selectively issued based on the user's user type, and further based on type of vehicle or type of vehicle plate. The notifications may be applicable to all user types and not restricted based on the type of user or type of vehicle. The notifications may be short, conveying traffic accident relevant data applicable to the location. The application may provide notification to the user to alert the user to potentially dangerous locations by notifying the user through email, text message, phone call, phone alert, voice mail, etc., by request or automatically as set by the user in advance

Another preferred aspect of the inventive disclosure includes UEP 115 that can be accessed by a user of remote computing device 111 through, for example, web portal 114. UEP 115 may be a function by which the user interacts with computing system 100 and one or more additional users. UEP 115 may comprise a specific UEP, although it is contemplated that the system according to the inventive disclosure may also include a general UEP. The general UEP is preferably for users to discuss and obtain information on general topics on how to avoid accidents (e.g., precautions for driving on a highway). The specific UEP may be operatively associated with specific locations where there are or have been accidents and might indicate specific reasons for these accidents at the locations, which may be voted on or rated by one or more users having firsthand experience. Optionally, the general UEP and specific UEP may be combined or otherwise interact with each other. The terms “general” UEP or “specific” UEP are meant for identification purposes only, in order to distinguish the type of information that is conveyed. The terms are not intended to limit the scope to a particular kind of device, application or system. In fact, the name “general UEP” and “specific UEP” can be changed by a user or by the system, and the name of the UEP can be labeled as a forum, section, part, or even re-named as “Panel A” or “Panel B,” for example. Regardless of which name is used, the purpose of identifying a portion of the system and the functions that it performs under the UEP remain the same as disclosed herein

Location identifier 112 may be configured as a GPS receiver or unit installed in computing device 111 and may be communicatively coupled or linked to server 102, database 101, and/or a data processing apparatus such as a microprocessor, of computing system 100. Computing device 111 may comprise clock mechanism 116 to identify current time and date. Location identifier 112 is preferably used to identify the current location of the user so that system 100 can alert the user when the user is within a customizable predetermined distance of one or more locations with accident history. Computing device 111 can include one or more speech recognition apparatuses in order to function in a hands-free mode. One or more locations with accident histories can be identified on a display of computing device 111 through different formats, such as colors, dots, patterns, lines, and circles (e.g., to identify specific locations, narrow areas as streets, broader areas as blocks, etc.). Additionally, a user may request location-specific information through UEP 115 on computing device 111.

Optionally, a data processing apparatus can be programmed to integrate algorithms or routines to detect duplicate data if accidents reported by the users match those already in database 101. If the duplications are detected, the duplicate data may be automatically removed. However, accident data not included or which does not match already stored data in database 101 may be added to database 101, and notifications reflecting such data can be accordingly updated to properly reflect any added data.

Exemplary embodiments of the inventive disclosure are not so limited and may also be expanded to encompass other systems or services which may process, utilize, and display the accident related data. Online mapping systems, GPS, or mobile communications device manufacturers, wireless service providers, mobile application creators and developers, etc., may greatly benefit from the information collected and disseminated.

An application running on computing device 111 can utilize the resources of computing device 111, which might include a data processing apparatus (e.g., a microprocessor), memory, location identifier 112, a wireless connection, a display, etc. The display may be the means through which notifications are shown to the user, or a notification may potentially be relayed through other media such as the audio system, etc. An application may additionally be incorporated with in-vehicle computer or navigation systems to enable the system to be fully integrated with a vehicle.

An embodiment of the inventive disclosure may also provide a street view function in UEP 115 of dangerous locations having a history of previous accidents. This feature may let the users see the actual road conditions before they start driving to their intended destination and further help them avoid getting into the accidents. Other media, for example, photographs, videos, etc., for such location may also be provided by the users or employees of the system of the mobile application. This is especially useful for those locations reaching a predetermined number of accidents where more information should be provided or for those locations that a user may be unfamiliar with, so users may have a better chance avoiding accidents. Additionally, the processing apparatus can transmit accident information, sometimes in the form of a notification, to remote computing device 111 for display. The accident information may comprise a plurality of accident reasons availed from database 101 for a location. Also, a display apparatus may work in conjunction with computing device 111, where the mobile application can trigger the delivery and display of information that is important to the user based on predetermined criteria which may include notifications, maps, interfaces, other relevant information, etc.

Dangerous locations where no accidents have actually occurred can also be collected through UEP 115. Numerous factors may contribute to a likelihood of an accident at such locations. Often, residents of areas might be aware of such locations (e.g., locations where there have nearly been accidents during times of poor visibility, etc.), and can report such details through UEPs 115. Factors that may lead to increased danger can include but are not limited to a high volume of vehicles, pedestrians, transit (e.g., buses) or delivery vehicles (e.g., mail trucks or vans) that may make frequent stops, low visibility or improper lighting, poor road conditions, construction, heavy industry and commercial vehicle routes, and lack of stop signs, traffic signals, or crosswalks. In addition, there may be factors relating to the designs of roads such as blind corners, high road speeds, and roads that are too wide or too narrow that make certain locations dangerous. Environmental conditions such as frequently flooded or washed out roadways, roadway grade, etc., can also contribute to potential dangerous conditions.

The display apparatus associated with computing device 111 preferably displays what is transmitted to it from computing system 100, for example, a notification configured to be integrated with an interactive electronic map API for display on an electronic screen. Additionally, a comparison of parking and traffic rules for different countries, states, cities, and/or municipalities may be displayed to help the users avoid accidents during cross-border (i.e., interstate, international, inter-city, etc.) traveling, where the users may not be as familiar with the local rules or common dangers. Since violation of parking and traffic rules (e.g., not observing the speed limit) may lead to accidents, a comparison of the relevant rules may be helpful in notifying users of the differences between the rules of their current location or their desired destination and those from one or more jurisdictions where the user was issued his/her driver's license and/or jurisdictions with which the user is already familiar. This enables the user to avoid traffic violations and/or potential accidents caused by such traffic violations, and thereby limit the potential dangers that come with being in an area with which the user is unfamiliar. The comparison of relevant rules is made based on the identified or current location of the user and, for example, a location obtained from the driver license or profile information of the user, which the user may enter when registering, or the system may be configured to obtain the information automatically from government sources. Information obtained from the driver's license might indicate the user's original location, and the stored parking and traffic rules from those locations are summarized, compared, and analyzed to alert the user to any differences between parking and traffic rules of the user's original location and the current location of the user or the location of the desired destination. The differences are then displayed on computing device 111 in a simple, concise, easy to read format. If such rules are in a different language, computing system 100 can translate them into the user's language before they are displayed.

UEP 115 allows users to exchange information and share ideas about traffic accidents and avoidance thereof. The user might be able to access UEP 115 directly or through web portal 114 on computing device 111. UEP 115 can cause location-relevant information to be displayed by identifying the location of accidents, which may be helpful to the user to obtain accident information. The display of UEP 115 may be divided into one or more categories based on the user type or the accident type. The specific UEP might organize content according to specific locations of traffic accidents. The general UEP may include a general discussion area for allowing users to share and exchange information and ideas about traffic accidents and avoidance thereof which might not be related to a specific location. The specific UEP may display questions, answers, and comments about traffic accidents at specific locations, organize content to clarify reasons for the traffic accidents, provide recommendations and share ideas, photographs, videos, and comments on how to avoid traffic accidents, as well as provide a street view function with photographs or videos of locations with accident patterns (i.e., when a number of accidents at a location or within a region reaches a predetermined threshold number as defined by a user or by the system). Both types of UEPs can be configured to be connected with each other (e.g., discussion of accidents at a specific location might apply to discussion of accidents in general). On receipt of a user report, server 102 may process and analyze the reported information subject to verification to store the information in database 101. Verification preferably ensures that all notifications to users are as accurate as possible. Optionally, the system may further comprise external and internal sensors to identify large commercial vehicles. Database 101 may then comprise images of the identified commercial vehicles. For example, the system may utilize internal and external cameras or sensors, as well as historical and crowdsourced data from database 101 to inform the users about approaching commercial vehicles, accident patterns involving commercial trucks at specific locations and issue alerts to prevent future accidents.

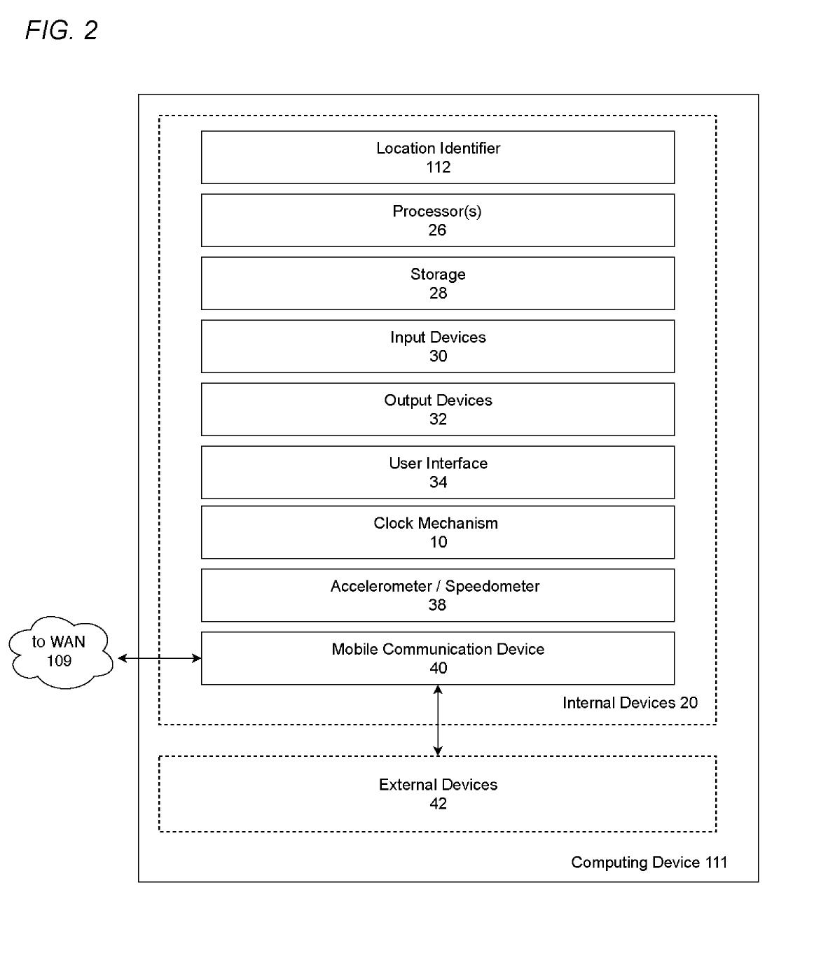

Turning to FIG. 2, shown is a schematic diagram illustrating a preferred configuration of computing device 111 for enabling a user to interface with computing system 100 by providing an interactive display where the user can see notifications, input information, provide voice commands, among other things, for reporting traffic accidents, for reporting other information relating to dangerous locations having a high probability of future accidents, and for receiving a notification with information relating to locations having a record of traffic accidents and details thereof, with reasons and/or recommendations for how best to avoid such accidents, or with a route plan to guide the user to an identified location or destination while avoiding areas with high rates of accidents. Remote computing device 111 may be in communication with all of its components, tangible or intangible, and may incorporate internal devices 220 and external devices 242 and may include and utilize mobile communication device 240 for receiving voice, text, and data for connecting to computing system 100 via, for example, WAN 109. Location identifier 112, such as a GPS receiver, may also be included in remote computing device 111 for identification of a location of computing device 111 (and thereby the user). Location identifier 112 may determine the location of remote computing device 111 in different ways, for example, through receiving location-based resources. One of ordinary skill in the art will appreciate that numerous approaches for providing location identification and location-based services may be utilized. In one example, location identifier 112 can be instantiated through processing received GPS data from location-based or geo-aware resources of computing device 111. In addition, location identifier 112 can also receive GPS data from other applications or programs that operate on computing device 111. For example, computing device 111 may communicate with one or more other applications using one or more APIs, which can use the location information to cause a user interface component to configure a user interface framework based on the location information.

Computing device 111 may also include one or more processors 226, storage 228, input/output (“I/O”) devices 230, 232, user interface 234, clock mechanism 116 and/or accelerometer/speedometer 238. Processor 226 may be used for executing instructions, software, or program modules on computing device 111. Storage 228 may be random-access memory (RAM) or flash storage. I/O devices 230, 232 may be used to connect the computing device 111 to other system implements, especially depending on the available functionalities of computing device 111. For example, an in-vehicle navigation system might not have a camera, while a mobile device may have a built-in camera. In this instance, a mobile device's camera may be used as an input for the in-vehicle navigation system. Other I/O devices 230, 232 may include a scanner, a microphone, a speaker, printer, etc. Remote computing device 111 may also include a display, which may be used to display a notification or other data to a user received from computing system 100. The display may, for example, be an electronic touchscreen display such as an LCD display, an LED display, an active-matrix organic light emitting diode (AMOLED) display, etc. Computing device 111 may also utilize internal clock mechanism 116 to determine the time at any given moment during its use. Accelerometer/speedometer 238 may be used to measure speed, acceleration, directional changes, etc. The system and method may also implement user interface 234 to display content based on user selections and preferences.

In certain embodiments, one or more of these components of remote computing device 111 might be combined to provide user features that are specific to user selections and user locations, and/or real-time conditions to enable a user to receive traffic accident related information. These selections can be displayed to the user, and the user can utilize user interface 234 to interact with the displayed information. For instance, user interface 234 can correspond to a program that is downloaded onto a smartphone or other portable computer device such as a tablet computer or personal digital assistant (PDA). A user can download and install the application on remote computing device 111. The system and method may utilize pre-programmed features combined based on certain protocols or methods of integration of basic components, such as server 102, database 101, mobile end applications, web portals, network settings, etc., where the applications may be applications written for ANDROID, a mobile platform developed by Google and the Open Handset Alliance, IOS, a mobile platform developed by Apple, Inc., WINDOWS PHONE, a mobile platform developed by Microsoft Corporation, etc.

A possible user interface 234 may include, but is not limited to, a homepage user interface, access to UEP 115, a summary interface, a location user interface, access interface, or a combination of any of the features described. One of ordinary skill in the art will appreciate that there are numerous user interfaces that could be utilized or contemplated for use with the inventive disclosure. External devices 242 may also be operatively associated with remote computing device 111 through either a wired or wireless connection and may include one or more devices that could provide additional or enhanced functionalities to computing device 111. External device 242 can include a mobile device such as a tablet, smartphone, an in-vehicle navigation system, other computing device, etc.

Other integrated devices may include utilization of vehicle equipment, for example cameras, inertial sensor, gyroscope sensor, GPS sensor, and any other applicable equipment, etc. This vehicle equipment may be used to obtain comprehensive real-time and historical activity information about the vehicle, for example, its direction, speed, orientation and acceleration, etc., in order to issue an applicable and accurate notification to the user. For example, these may be integrated with in-dash systems to enable full function within a vehicle. This integration is not limited to in-dash systems and may also be integrated in the vehicle by original equipment manufacture or third-party add-on equipment that may be mounted within a vehicle. The inventive disclosure may use direct integration of the disclosed traffic accident avoidance information system into the navigation and GPS in an onboard computer of original equipment manufactured vehicles. In such embodiments, the disclosed architecture can be integrated directly into a vehicle's computer system. When integrated into an in-dash navigation system, the vehicle's display may be used to show an accident related notification. The in-dash integrated system embodiment can provide remote updates and communications to the user through an installed traffic accident avoidance application on remote computing device 111.

The system and method may optionally include or utilize a geographical information system (GIS) to capture, display, and otherwise analyze data. The GIS may integrate an electronic or digital map, for instance, as a layer (i.e., GOOGLE MAPS, which is an electronic mapping service provided by Google, a subsidiary of Alphabet Inc., etc.) to be viewed on computing device 111. With this integration, roadways may be displayed from a map database which presents the analyzed data as to route planning to an identified location or destination while avoiding locations having a record of high instances of accidents, where the options can be displayed to the user to help plan his/her route accordingly, see automatically generated suggestions about routes, etc. However, a user may have the option to select an alternate route based on additional route criteria. For example, a user may select a longer route based on distance even though a shorter route only has a limited number of reported accidents. The GIS may integrate different layers, and data points with similar attributes can then be isolated and output as a layer that can show instances of certain data points that have similar attributes. Then, an inventory of other data points such as number of accidents, user types involved in the accidents, the time of day during which the accidents took place, etc., can be gathered and applied through a GIS and output to computing device 111 and visualized on an electronic map. This provides a way to usefully sort, access, and send the data to users of computing device 111.

The GIS might include certain hardware, which may be another computing device or secondary device attached to it that enables the GIS to be functional, and software such as algorithms written using executable programming languages to store, analyze, and display geographical data and information. The GIS can be used to process certain data such as high traffic areas, confusing parking or traffic locations, maps, etc. The GIS might be maintained by a technician, or other qualified personnel, with knowledge of upkeep procedures, especially those concerned with adjusting system functions to what might be required of a GIS.

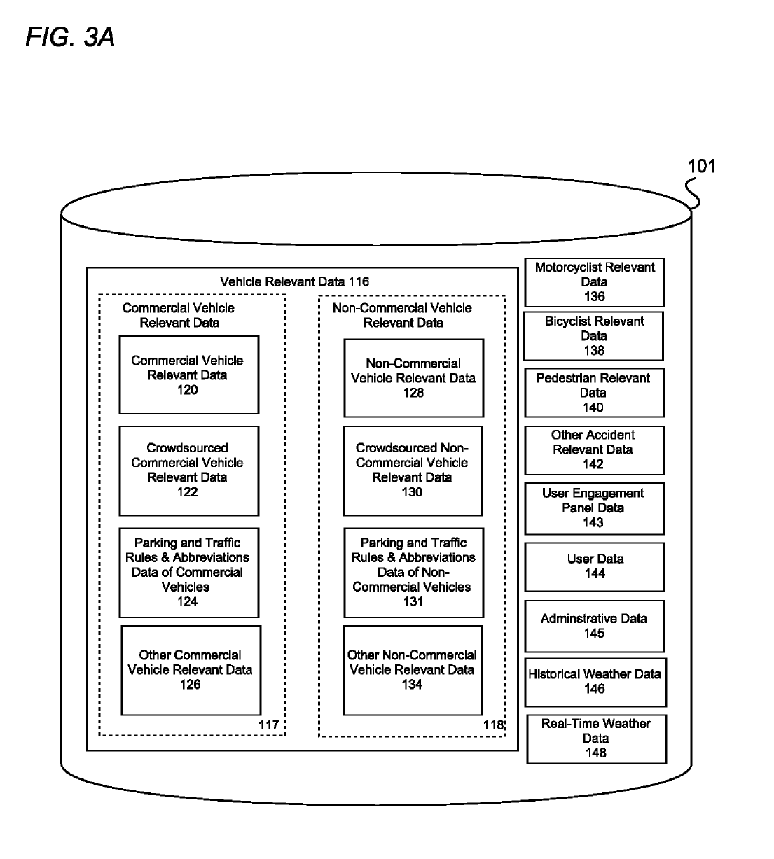

Turning to FIG. 3A, shown is a schematic diagram illustrating a preferred structure, content and organization of database 101 in accordance with various exemplary embodiments of the inventive disclosure. The system may use database 101 or a set of databases (or data storage media) disposed on a hard disk, one or more hard disks, or other storage means. The information in database 101 may be stored in a non-relational or unstructured manner. Additionally, there may be at least one backup database that may back up a primary database periodically in case of data loss in the primary database. While referenced as a “database,” one of ordinary skill in the art will appreciate that in practice this could be implemented in numerous embodiments, including but not limited to a data storage medium, whether structured or unstructured, relational, or otherwise, and that there are numerous methods of providing databases and data storage media for the organization and retrieval of specific information, contemplated for use with any appropriate database 101 or other storage means. Further, as stated, the exemplary embodiments disclosed herein may incorporate multiple types of data corresponding to multiple types of users, or one type of data corresponding to multiple types of users, or multiple types of data corresponding to one type of user. In some implementations, database 101 can be located and accessed remotely with respect to computing system 100.

A user may initially provide and periodically update user data (e.g., user customizable preferences, notification preferences, settings, or other customizations) stored in database 101, including any and all user preferences, notification preferences, and/or settings, among others. When a user first interfaces with UEP 115 and requests to configure or customize UEP 115, database 101, remote computing device 111, or any other part of computing system 100 (e.g., the creation, update, and deletion of preferences, settings, or customizations), computing system 100 checks any user security information with respect to remote computing device 111 to determine whether the user is authorized to complete the user interface configuration. In some instances, access to database 101 through remote computing device 111 and UEP 115 may be restricted, and it may be determined whether UEP 115 is configurable according to any user security information managed by computing system 100. If it is determined that the user is authorized to complete the configuration of the user preferences, settings or customizations, the user may be provided with a series of prompts querying the user to configure UEP 115, remote computing device 111, or information within database 101 relating to any and all user settings or preferences, notification preferences, other setting or customizations, etc. Computing system 100 may be configured to automatically set or populate by default certain user preferences, notification preferences, settings, and other customizations stored in the database if these values have not been manually input by the user.

Once the user configuration or customization is complete, computing system 100 monitors and analyzes the settings, preferences or customizations input by the user and compares the data with data already stored within database 101. Computing system 100 transmits the results of the monitoring to database 101 to update the user preferences, settings or customizations stored therein. During use of the system, the stored settings, preferences or customizations may continually or periodically accessed for use in the generation and transmission of customizable notifications to the users. The system may also use default settings for the generation and transmission of notifications to the users.

The data stored in the database 101 may be categorized into a plurality of main data sets, such as vehicle relevant data 316 (i.e., commercial or non-commercial), motorcyclist relevant data 336, bicyclist relevant data 338, and pedestrian relevant data 340, as well as into other data sets such as other accident relevant data 342, UEP data 343, user data 344, administrative data 345, historical weather data 346, and real-time weather data 348. The data set for vehicle relevant data 316 may be further categorized into commercial vehicle relevant data 317 and non-commercial vehicle relevant data 318. Commercial vehicle relevant data 317 may include historical commercial vehicle relevant data 320, crowdsourced commercial vehicle relevant data 322 (real-time or other), parking and traffic rules and abbreviations data of commercial vehicles 324, and other commercial vehicle relevant data 326. Non-commercial vehicle relevant data 318 may include historical non-commercial vehicle relevant data 328, crowdsourced non-commercial vehicle relevant data 330 (real-time or other), parking and traffic rules and abbreviations data of non-commercial vehicles 332, and other non-commercial vehicle relevant data 334. One of ordinary skill in the art would appreciate that the database may not necessarily include all of the four main data types. Instead, it may be configured to include the data of only one data type, a combination of several data types, or even additional data types. For example, if the system according to the inventive disclosure is configured to be utilized only by users of certain types of vehicles, such as autonomous vehicles, the database would only include traffic accident relevant data that only pertains to vehicle accidents, whereas the database would not include any data pertaining to, for example, motorcyclist-bicyclist collisions.

Once the data in database 101 is standardized and made unambiguous, computing system 100 may analyze the data to understand the reasons for the occurrence of traffic accidents in a specific area or for a specific location. This analysis may be performed using rules that take location, day and time as input and provide an indication as to whether the given location, day, and time is associated with any traffic accidents as output. The data in commercial vehicle relevant data set 317 and non-commercial vehicle relevant data set 318 may be retrieved to generate the corresponding notifications for relevant users. To do so, computing system 100 may also retrieve data from user data set 344 that includes user information data, such as user profiles, settings, preferences, type of the vehicle, type of vehicle plate, etc. The parking and traffic rules and abbreviations data of commercial vehicles 324 and of non-commercial vehicles 332 may be retrieved to help standardize parking and/or traffic violation data, as this data may be useful in avoiding accidents. Additionally, other traffic accident relevant data 342 may be retrieved from database 101. Historical weather data 346 may be used in conjunction with real-time weather data 348 to determine if a notification is to be sent to users whose current location indicates that the user may be subject to weather-related accident advisories to help avoid any potential accident due to the same or similar weather conditions.

In an alternative embodiment of database 101 in accordance with the inventive disclosure, FIG. 3B shows that vehicle relevant data 316 in database 101, may include non-commercial vehicle relevant data 318 and commercial vehicle relevant data 317, may further include data sets such as type of vehicle relevant data 350 and type of vehicle plate relevant data 360. Type of vehicle relevant data 350 may further include historical type of vehicle relevant data 352, crowdsourced type of vehicle relevant data 354, parking and traffic rules & abbreviations data of type of vehicle 356, and other type of vehicle relevant data 358. Type of vehicle plate relevant data 360 may further include historical type of vehicle plate relevant data 362, crowdsourced type of vehicle plate relevant data 364, parking and traffic rules & abbreviations data of type of vehicle plate 366, and other type of vehicle plate relevant data 368. UEP data 343 and administrative data 345 may also be provided for the storage of miscellaneous information provided through UEP 115, as well as to store any administrative type information or data as may be needed by the system. It will be understood by one skilled in the art that database 101 may be updated and synced dynamically whenever there are changes or updates to the data. Any backup database related to database 101 may also change accordingly to reflect the latest changes, and such information may also be organized or structured in a manner allowing for effective sorting and retrieval.

A user may access historical records, explore database 101, and retrieve related data from a search function or other means. Each time an input or request from a user who wants to see related information is made, a safe access channel with database 101 may be opened and computing system 100 may send out the query through the access channel to a database management module. If database 101 is a relational database, then the data tables may have one kind of relationship, such as one-to-many relationships, many-to-many relationships and one-to-one relationships with other data table(s). Based on the relationships between data tables, the database management module may follow the query and find the specific data table(s) by using ID(s), table names and columns names of the tables with or without joining two or more data tables together. If database 101 is a non-relational database, instead of data tables, then the data may be stored in key-value pairs, and the database management module follows the query and finds the specific data by using keys that the query provides. Whether a relational or non-relational database is used, after the database management module retrieves the targeted data, then computing system 100 may send the search result back to server 102 through the secured access channel. The secured channel is then closed until the next time it needs to be opened. The relevant traffic accident data that has been organized within database 101 may then be retrieved and displayed.

Database 101 may also be capable of storing a plurality of parking and traffic rules, signage data, violation codes, historical traffic accident relevant data, crowdsourced traffic accident relevant data (real-time or historical), etc. The traffic accident relevant data may include a variety of sub-data, such as geolocations, reasons, time and date of the accident, category of accident, number of vehicles and people involved, such as age, gender, etc. Database 101 may be populated by receiving the historical records from an official source (e.g., government websites, public resources, etc.), receiving crowdsourced information or records from a plurality of users, verifying accuracy of the received historical and crowdsourced information or records, adding any new accident data, and removing any duplicate accident data from database 101.

Since the data in database 101 may be categorized into a plurality of main data types, each user category (e.g., vehicle user, motorcyclist, bicyclist, pedestrian, etc.) may access traffic accident relevant data of the data type corresponding to their user type as well as data of other data types to suit their interest. The user may change categories and customize notifications at any time. For example, the users who elect to receive notifications for a pedestrian because they are currently walking on the street may receive notifications on computing device 111 alerting them to the locations with high accident activity involving pedestrians, but using UEP 115 may switch, for example, to a motorcyclist user type and receive motorcyclist relevant data and/or vehicle relevant data at a later time. The system may cluster or categorize the data according to the user categories or data types to allow for more efficient data retrieval and processing, and to provide more accurate notifications according to each user group. At the same time, if the users are interested in receiving alerts for another user category or multiple user categories, they are able to indicate that in the system settings and access information of any of the categories according to their interest. Regardless of the user category selected by the user, an alert may be issued by the system in advance for a location that the user selects or one that he/she is approaching.

The system optionally integrates with third-party APIs to provide users with access to real-time schedules of trains, buses, subways, etc. at specific locations comprising crossings or other intersections to alert the users about potential dangers related to approaching means of public transportation and an alert triggered for the users related to potential accidents. The system identifies dangerous locations with inadequate road traffic control devices. Information about dangerous locations may be collected from government agencies and other sources of open data from government agencies, various informational sources comprising newspapers, social media, blogs, etc., and supplemented by users' reports and the administrator of the system. Computing system 100 and databases 101 might store all locational information, historical traffic accident relevant data, and crowdsourced traffic accident relevant data for the different user categories.

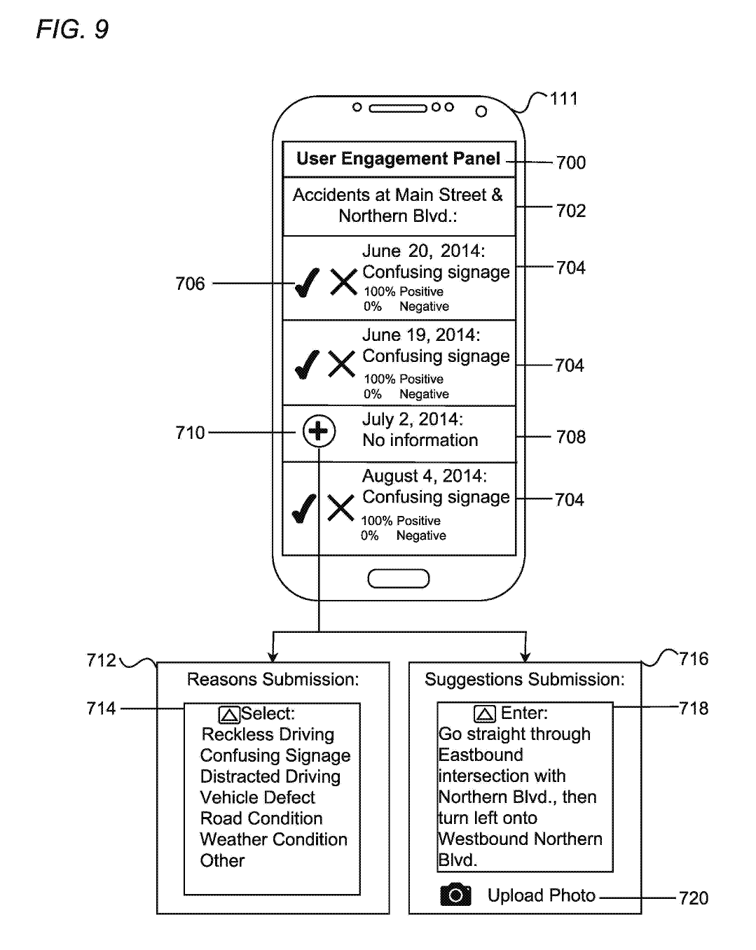

A system and method are also provided to build a database of accident locations and traffic and parking rules according to the type of vehicle and type of vehicle plate, traffic accidents, as well as road conditions that may lead to accidents. The method comprises collecting and storing information related to accidents and updating the databases' accident information in real-time or within a reasonable time. The accident related information may include, but is not limited to, date, time, borough, zip code, latitude, longitude, location, street names, vehicle types, reasons, ages, number of pedestrian injuries or fatalities, number of bicyclist injuries or fatalities, number of motorist or passenger injuries or fatalities, street direction, street type, surface condition, surface type, road condition, road type, alignment, weather, lighting, etc. If database 101 has information missing, such as reasons for the accidents, such information may be provided by any users reporting the accidents with full details through UEP 115 identifying the specific locations where the accident occurred. In certain embodiments, the users can also select, using UEP 115, from a list of reasons to identify the reasons of the accidents if the reasons for accidents are not clear or not identified (see, e.g., FIG. 9). In certain embodiments, only the users having firsthand experience with the accident location or the users within a specific distance of the accident location may be allowed to rate the validity of the reasons using the UEP. This way, the system may differentiate between the users with direct knowledge (e.g., firsthand experience) or indirect knowledge (e.g., secondhand knowledge) of the accident location, which might ensure more credibility to identification of the reasons for the accident.

Database 101 may also include historical accident data collected from various sources that include, but are not limited to the government or government websites, government agents, such as police departments, law enforcement, TV, radio, various social media, municipalities, non-government organizations (NGO's), private entities, community organizations, interested individuals or users, websites containing useful information such as law enforcement abbreviations, blog posts, social networks, newspapers, professional articles, publicly available sources, other resources where historical accident-related data can be collected, etc. (hereinafter, “informational sources”). TV and radio are important sources of up-to-date credible information and accident locations. News analysts examine, interpret, and broadcast news, either recorded or live, from on-the-scene reporters. Thus, credible information may be received faster from them rather than through government websites or the users' reports. Data may also be obtained by the system through, for example, a police precinct's website, and subsequently stored in database 101 to be analyzed for patterns based on a predetermined number of accidents defined by a user or by the system. Some of the vehicular accident data sources include government agencies which collect traffic safety data (e.g., the U.S. Department of Transportation in the United States), data collection websites, newspapers, articles, blogs, etc. All collected information from periodicals may be assembled and summarized by a system administrator or employee to supplement database 101. Some of the accident data may also be provided as public open data from the government agencies. Websites created by communities or interested individuals may also contain relevant accident and accident prevention information. The system administrator, employees, or third-party contractors may be hired to search, gather, and input accident information from these various sources into database 101.

Although locations from government data regarding accident information may not be as accurate or complete as geolocation coordinates when it comes to specific instances of accidents, it is still useful because it provides accident data generally in areas that are credible and resourceful despite not being timely updated. Therefore, locations from government accident data may be converted to geolocation coordinates through various third-party software, and then input into database 101. There is a need for up-to-date real-time or close to real-time traffic accident information quickly shared with other users. It will be appreciated that there are benefits to providing improved techniques for obtaining and analyzing accident data with sufficient details to provide current traffic road conditions and reasons for the accidents. This leads to reducing risky user behaviors, prevention of vehicle accidents, and overall road safety.

In an alternate embodiment of the inventive disclosure, there may be a road condition data set in database 101, such as, for potholes (i.e., a primary cause of traffic accidents), historical data may be collected from government websites about dangerous potholes along their routes. Certain cities and municipalities or public entities often endeavor to maintain roads and highways so they are free of damages and defects, and the system may be used for educational purposes to help the users avoid accidents, as well as help establish negligence on the part of the city or county that could aid in receiving financial compensation in the case of injuries and property damage. For example, a video or a picture with the location on the highway (e.g., a street view) may be uploaded to the system or retrieved to alert the users about dangerous curves or potholes that could affect driving safety or lead to vehicle damage or an accident. While a bumpy road may be a nuisance to drivers, a road littered with potholes can cause serious property damage to the vehicle and even result in accidents. Motorcyclists are at special risk because a motorcycle has less weight and only two wheels on the ground. Even when wearing a helmet, a pothole accident on a motorcycle can cause serious injury and even death.

Similarly, bicycle accidents caused by potholes are a serious concern for bicyclists, as they can injure the bicyclists who might be thrown off a bike because of braking suddenly to avoid a pothole or being hit by a vehicle when suddenly swerving around a pothole. Even potholes that are small can cause damage, cause a tire blowout, or put a huge strain on a vehicle's shocks and suspension. When a vehicle goes over a big enough pothole, the vehicle may not be able to handle the blow. This sudden and unexpected impact can cause a driver to lose control of their vehicle, and as a result, end up in an accident. A large pothole can cause an impact similar to a 50 kilometer per hour (kmh) accident, which can cause severe damage to the vehicle and result in an accident. Even with all the highway repairs and construction, there are more and more accidents caused by potholes that have been neglected by cities and/or counties for far too long.

Data relating to traffic accidents may be collected and used to provide users with accurate and effective notifications of the reasons behind previous accidents in certain locations, as well as to provide information regarding dangerous locations. The data collection at the scene of accidents is primarily done by law enforcement, which may be a valuable source of information. In addition, users' accident reports can be used as secondary data. The collected data from any source may include various parameters, for example general information such as date, time, person involved in an accident, classification of the accident, such as fatal, serious, minor, etc., location information such as a description or details of location of accident, details of vehicles involved, such as registration numbers, description of vehicle, loading detail, vehicular defects, the nature of an accident such as details of collision, damages, injuries and fatalities, road and traffic condition such as details of road geometry, surface characteristics, type of traffic, traffic density, weather, etc., primary causes of accidents, and/or accident costs such as financial losses incurred due to property damage, personal injuries, and casualties.

Database 101 may also include other types of publicly available useful and critical resources, for example, violation and insurance codes, vehicle damage codes, abbreviations and their common meanings as used by law enforcement. Law enforcement officers often use abbreviations when writing accident reports. On the reports, abbreviations may appear in the area where the officer specifies the accident location and reason(s) for the accident. Abbreviations may be processed and stored in database 101 by gathering data from publicly available sources to provide the most accurate and up-to-date meanings. Database 101 further stores traffic accident relevant data including geolocations, reasons, time and date of the traffic accidents. The data processing apparatus can cross-correlate an identified or current location of a user with a time and a location of each of the accidents to predict a likelihood of an accident at the current location of the user, time and date. The accident information preferably comprises a plurality of reasons for past accidents for the current location of the user or a location requested by the user.

When no open government accident data is available for specific locations, the system may obtain historical accident data through input from other users and/or interested individuals, or a system administrator may collect accident data from private entities, or from informational sources. This collected accident data may also be supplemented by crowdsourced accident information from users having firsthand experience with the specific location, and such users may report any real-time (or otherwise) accidents to database 101. Examples of the crowdsourced data other than from accident locations may include, for example, information about improper construction zone restrictions (e.g., construction crews may fail to safely block off construction zones that are building in progress, thus resulting in an increased probability of accidents). Here, a user may report the improper construction zone restriction in real-time.

Optionally, the system may promote transparency and accuracy for accident prevention in utilizing combined raw data from various sources and then creating database 101 and platform for the users to access collected information in a user-friendly mobile interface. To build database 101, raw accident data may be obtained from informational sources that may be uploaded to a computer microprocessor and formatted to include only relevant information needed for running analyses and providing notifications relating to the avoidance of potential traffic accidents. The uploaded accident data may be then split into two sets for cleaning and uploading into the system's server. The first set may be accident data which is already verified as having all the necessary information in the right format while the second set may be accident data which needs to be reformatted to include all necessary information. Once all accident data has been cleaned, the address data may be extracted in a data frame to be used in a third-party geocode API to output a .csv file with all the geocoding information of locations relative to each accident. The output may be reviewed and corrected by the system administrator for accuracy and completeness. Sign data and rules, regulations, laws and codes (RRLC) data files may also be uploaded, cleaned and merged with the accident data into database 101.

The raw data entered, processed, stored, and analyzed may include but is not limited to the type of accident, the causes/reasons for the accident, date and time of the day, registration location of vehicles, vehicle type, plate type, license issue date, place, city, municipality, and/or state of residence of people involved, relevant laws broken or involved, etc. Reasons for accidents can include but are not limited to distracted driving, driving while texting, drunk driving, speeding, running red lights, running stop signs, inexperienced drivers, age of drivers or people involved, marking or sign design defects, etc. These reasons may be used to generate applicable alerts for the users at the specific location and may optionally be voted upon by users who have firsthand experience if such reasons are not clear in the original accident report.

Database 101 may also comprise historical traffic accident relevant data (i.e., including past or current data other than crowdsourced data, which is publicly reported and obtained automatically through by the system from any number of private, government, educational, or other informational sources) interactively and dynamically correlated to crowdsourced traffic accident relevant data. Crowdsourced data may or may not occur in real-time. Optionally, the traffic accident relevant data may be analyzed according to statistical measures (i.e., measures of central tendency, mean, median, mode, etc.) of various accident related factors to identify at least trends or factors for causes of traffic accidents, which may be further analyzed to infer relevancy to an age, a specific age group, a time frame, a time of day, a day of week, a day of month, a day or time of year, a weather condition, etc.

The system may also collect and analyze all relevant users' information, including but not limited to gender, age, education, ethnicity, occupation, etc., which may be used for statistical purposes, for example, to infer information about which types of accidents are relevant to a specific age group, ethnicity, time of the day, day of the month, etc. For example, inexperienced drivers are known to get into more accidents at night than during the day, whereas for senior drivers of age 65 and up or new inexperienced drivers, the possibility of getting into an accident may increase at night or in the winter time. Similarly, statistical analyses of incidences of accidents based on characteristics such as gender, ethnicity, education level, etc., may be used to infer or predict potential accidents for users having the same or similar characteristics.

Alternatively, the system may infer from the stored data potential traffic accidents at certain locations based on certain relevant data stored in database 101. For example, computing system 100 may infer a traffic accident based on location or range of locations (i.e., a length of a street, a series of streets, a neighborhood, etc.) to preclude that location or range of locations from a particular route plan for the user (or to be able to properly alert the user as the user approaches or passes through the location(s)). The inference may be based on different times corresponding to a location. At a given location, where each of two relevant times less than a predetermined amount of time apart (e.g., the two relevant times within a predetermined time frame) have at least one prior accident for a given location, and the present time is between the two relevant times, the system may infer or predict a potential traffic accident for the user at the location at the present time. The time frame may be based on a point in time such as a time of day, a time of week, a time of month, or a time of year. Additionally, computing system 100 may predict potential traffic accidents applicable by inference based on at least two relevant locations corresponding to at least two relevant times. The location of the traffic accident here is between at least two relevant locations at a predetermined distance from each other corresponding to the present time being between at least two relevant times within a predetermined time frame.

Computing system 100 may also predict potential traffic accidents applicable to the user by inference based on prior accidents at a location irrespective of time but based on the type of vehicle or the type of vehicle plate. That is, computing system 100 may predict by inference whether a location is likely to have a potential traffic accident based on whether the previous traffic accidents were for a same user type of the user. Similarly, computing system 100 may also predict by inference whether a location is likely to have a potential traffic accident based on whether the location falls between at least two locations for which there is a record of a predetermined number of prior traffic accidents for the user type of the user and the two locations are within a predetermined distance of each other.

Computing system 100 may also predict by inference whether a location is likely to have a potential traffic accident based on at least two relevant locations corresponding to a time, where each of the two relevant locations has a record of a predetermined number of traffic accidents for the user type of the user. Here, at least two relevant times correspond to one relevant location, where each of the two relevant times has a record of prior traffic accidents for the user type of the user (e.g., the present time is between the two relevant times and the two relevant times are within a predetermined time frame, which may be based on a point in time such as a time of day, a time of week, a time of month, or a time of year), and/or at least two relevant locations correspond to at least two relevant times. The location inferred to have a high incidence of traffic accidents would be between at least two relevant locations at a predetermined distance from each other corresponding to the present time being between at least two relevant times within a predetermined time frame. These predictions, which are directly applicable or applicable by inference to the user, may cause the location to be identified as a potential dangerous location and reasons and/or recommendations may be provided as to how to avoid such location. A direct correlation may be in such a case where there have been one or more traffic accidents at the current location at the current time, which relates to the same user type, and the same type of vehicle or type of vehicle plate. For example, a direct correlation may be when a non-commercial vehicle user is provided with a notification that warns of potential traffic accidents at Location X at 5:15 PM on a Tuesday because there is data in database 101 which matches the situation (e.g., a non-commercial vehicle being involved in a traffic accident at Location X at 5:15 PM on a previous Tuesday, a plurality of directly matching data points—type of user, type of vehicle, location, time, etc.—all correlate directly (i.e., are identical or nearly identical)). In this case, a potential traffic accident does not need to be inferred, as there is are exact data points which establish the basis for the notification.

Notifications may comprise accident advisories including suggested routes based on the number of traffic accidents along each route. In addition, the system may advise the users in real-time about roads and locations where they may encounter accident related lane closures or heavy traffic delays. The notifications can be integrated with a route planning mode through a navigation device or computing device 111 able to provide directions. The accident notifications may comprise accident related data retrieved from database 101 and may include alerts for the user along the route and suggestions of one or more routes to the user to an intended destination with the least number of accidents, based on an identified location, an identified time, the user preferences or customizations, and/or the user type.

It will be appreciated that such route planning functionality provided by the systems and methods described herein may be configured to account for a user's driving history, such as experience level, age, number of prior traffic accidents, etc. A more “difficult” route (e.g., one with more prior accidents) which is shorter may be acceptable for an experienced driver and/or one with an excellent driving history, and unacceptable for an inexperienced driver and/or one with a poor driving history. By way of example, the system may be configured to only provide an inexperienced and/or poor driver a suggested route along which select locations have been identified as having less than a certain limited number of accidents (e.g., 5, 10 . . . 50) over a certain time period (e.g., 1, 2 . . . 10 years) based on user preferences and/or customizations. The number of years for the certain time period can be set by the user through the user preferences, settings or customizations, or computing system 100 can automatically set or populate the certain time periods by default. By contrast, computing system may be configured to provide an experienced and/or excellent driver a suggested route along which select locations have been identified as having a greater number (e.g., up to one hundred or more) of accidents over the same time period. In this manner, greater or less restriction can be used for the route planning depending on user sophistication and driving experience. Such configuration can be accomplished at the time at which the user preferences are set.

A user can be provided with customized notifications including information comparing the same or similar weather conditions indicated by the data pertaining to the historical accident data related to weather forecasts to obtain potential weather-related accident information. The method for alerting a user may further comprise obtaining information relating to road conditions and high-risk locations from database 101 and displaying the traffic accident relevant data to the user. Potentially dangerous locations comprising intersections, streets, and other locations that have many accident occurrences can be identified, and the user can be forewarned. The dangerous locations might include places that have no stop signs, signal lights, other types of traffic control devices, posted speed limit, etc., may be a school zone, a daycare zone, a senior center zone, a railroad crossing, an area of high volume of pedestrians, an area of high volume of vehicles, etc., may have limited visibility, or may be some other dangerous location. This information is used to alert the user about dangerous locations and inform the user about an increased possibility of traffic accidents.

Computing system 100 may be capable of identifying large commercial vehicles comprising trucks and trailers, which may also include government vehicles. Computing system 100 can transmit alerts to the users more likely to get into an accident and inform those users about approaching large commercial vehicles and their routes. The routes of trucks or trailers may be identified by colors, patterns, or other formats. For example, the darker colors may identify routes of large commercial vehicles with a history of many accidents, while lighter colors may identify routes with a history of less accidents. The settings that relate to receiving alerts and notifications can be changed by the user per the user's preferences. The alerts and notifications, set in the user preferences, may be repeated for a preset number of times and shut down. Additionally, the alerts or notifications can be customized for location, number of previous accidents, distance, time, and format, and may be voice, text, SMS, or any combination thereof.

A reward or award may be credited or issued to users who report new accident data for a specific location, including, but not limited to, the date, time, location, reasons, how to avoid the accident and other accident related information. The report is subject to ratings (e.g., positive or negative) from other users who have firsthand experience, which can be established by determining whether the user has passed by the location or within a predetermined distance of the location with accident based on the user's geolocation history which can be stored in a database, or if the user has received a notification including at least a portion of the traffic accident related data pertaining to the location. If the positive ratings reach a certain threshold, then the system may reward the user who submitted the initial report of new accident data. For quality control purposes, the system and method may integrate a verification system. For example, UEP 115 may track ratings to keep track of participating users, so that each user engagement submission is only endorsed once per user, in order to prevent abuse of the reward system. Additionally, users may rate the notifications by either endorsing or rebutting the notification received when the user is indicated to be within a predetermined distance of a location having had one or more accidents.

The user may set the preferred method of communication, which may include email, text message, phone call, phone alert, voice mail, etc. A user may customize notifications depending on the user's preference and driving habits. In terms of distance adjustments, the user who is quick to react when alerted may set a notification to be displayed when he/she gets to within a predetermined distance (e.g., 20 meters) in advance of the accident location. The user who is slow to react when alerted may want to set a notification to be displayed earlier (e.g., 75 meters) in advance of the accident location to allow the user more time to react accordingly. In terms of time adjustments, the users may indicate in the user preferences the amount of time before arriving at a location to receive the alert notifications. The system may also allow for the users to adjust the number of times these notifications may repeat along with the distance at which the notifications are displayed depending on the user's preferences. An abundance of alerts in a brief period of time can also be unnecessarily distracting to the user as it takes the user's attention off the road to turn the notifications off. Therefore, the application may allow users to turn these alerts on and off or have them provided audibly within the settings for the user preferences. The user may also choose which notifications to receive while on route to a destination. Users who are familiar and experienced with a certain route may turn off a notification if they do not wish to receive updates. If the user readily understands the notification, the user may want to receive the alert notification only once. However, if the user needs the notification to be repeated, then the user may set the alert to appear at different intervals of time depending on the user's preference (e.g., 30, 75, or 100 meters ahead of arriving at the planned destination). The user may speak into computing device 111 to turn notifications on and off. Functionalities within the system of the mobile application, notably the user reporting function, may integrate with third-party APIs to provide voice-to-text capabilities. The users who utilize the voice-to-text function may record their voice by speaking into the microphone of computing device 111, so that the system may change any voice command or input to a text equivalent within the mobile application.

Also included is a method and system for mobile notifications generated from database 101 that involve the processing and analysis of several data set components, such as available historical and compiled data from informational sources, crowdsourced data from users' inputted accident related information, rules and abbreviations data, traffic sign locations and any and all supplemental information as provided and/or verified by the administrator of the system, all of which are subject to review and/or ratings. Data may be labeled in database 101 according to its source, and the system may use a team of professional individuals with relevant expertise in traffic accidents and/or parking and traffic rules to verify and provide more accurate data for database 101. Notifications can be changed or updated depending on data gathered and user reports.

Notifications may be brief alerts accompanied by information about previous accidents at the location. The information may be kept short because users may receive these notifications while driving. Additionally, for ease of use, if notifications were turned off, computing device 111 may turn notifications on again after the users have finished travelling through that route. Users in a new area may set up to receive more notifications to ensure having the safest travel options. Since notifications may be based on data points, users may preset different ranges in the number of accidents before a notification is issued. For example, one user may deem a location having had ten (10) accidents a risky or potentially dangerous location, whereas another user may deem a location having had ten (10) accidents not to be a risky or potentially dangerous location. Additionally, the notifications are generated based on the user types, type of vehicle, and/or type of vehicle plate applicable to the user receiving the notification and may act as persuasive information to inform the user of potential accident causes.

Database 101 may store various accident types which may include but are not limited to vehicle-vehicle, vehicle-motorcyclist, vehicle-bicyclist, vehicle-pedestrian, motorcyclist-motorcyclist, motorcyclist-bicyclist, motorcyclist-pedestrian, bicyclist-bicyclist, bicyclist-pedestrians, etc. Additionally, vehicle-vehicle accident types and other accident types involving at least one vehicle may be further categorized according to commercial vehicle or non-commercial vehicle. Accident types involving a commercial vehicle may be further categorized based on the type of vehicle or type vehicle plate. For example, vehicle rollovers are a common type of accident (i.e., vehicles having a higher center of gravity and high vehicle speeds have increased likelihood of a rollover). Vehicle rollovers are exceptionally dangerous for pedestrians and passengers, where the severity of injury is increased. Similarly, accident types involving non-commercial vehicles may also be further categorized based on the type of vehicle or type of vehicle plate.

Other examples of common accidents are bicycle collisions with vehicles at intersections. Although the intersections represent a relatively small portion of a bicyclist's travel route, they are where a bicyclist is most at risk of getting hit by a vehicle. To minimize this risk, the bicyclists need to understand the rules of the road, learn to recognize some of the most dangerous intersection hazards, know the accident patterns at specific locations along their route, and take safety precautions when approaching and riding through an intersection. Vehicles may also not be aware of some of the uncertainty that bicyclists might face at intersections. Computing system 100 can process the bicycle accident data and may discover dangerous patterns based on a predetermined number of accidents defined by a user or by the system within certain locations and send notifications to users about potential dangers. Users who are bicyclists may be alerted to these locations and take caution or avoid such locations and intersections, and vehicle drivers can take steps to help accommodate bicyclists on the road.

Another accident type is a commercial vehicle collision. Commercial trucks present unique dangers for drivers, as well as other vehicles, pedestrians, motorcyclists, bicyclists and any passenger due to their size, and their driver's limited visibility, thereby requiring extra precaution. Additionally, trucks have larger blind spots where a commercial vehicle user has limited or no visibility (i.e., the “No-Zone”). Therefore, a potential risk exists when a user of a non-commercial vehicle merges lanes or misjudges a large commercial vehicle's visibility or ability to maneuver around the non-commercial vehicle in time. No-zones can be dangerous even in the best conditions but can become increasingly dangerous for a driver or for those around a vehicle when the vehicle is in an impact zone or a dangerous location. For example, other unsafe acts committed by non-commercial vehicle drivers in the vicinity of large trucks may include driving to the right of a truck that is making a right turn, misjudging an approaching truck's speed at an intersection, and making a left turn in front of the truck, causing a truck to maneuver or brake quickly, failure to slow down or speed up when a truck begins to change lanes or merge, unsafely passing a truck, being blown out of position by air turbulence or cross-wind, pulling into traffic from the roadside in front of a truck without accelerating sufficiently, driving between large trucks, abandoning a vehicle in a travel lane, failing to get a disabled vehicle completely off the highway and onto the shoulder, etc. Accordingly, based on user's preset preferences, the system may only transmit a notification for a given accident type or types to a user. In addition, a user may provide a preset preference as to how many accidents need to have occurred at a particular location for the system to transmit a notification about that location to the user.

Before a user begins an intended route, the system may alternatively assist the user in advance by integrating with a third-party API to retrieve weather related information to determine whether the system should send reminder notifications to alert the user. If the system detects one or more accidents at the location involving a vehicle or vehicles with similar conditions or attribute as the user's vehicle, and the weather conditions at the time of the accidents are determined to be the same or similar to the current or expected weather conditions at the location, then the system may send a reminder notification to alert the user to perform a general or specific check of his/her vehicle. For example, the system may monitor the weather conditions (e.g., forecasted weather) and alert the user before any forecasted snowstorms to check the brake fluid, and/or replace the windshield wipers, if such replacement is needed based on the vehicle's identified mileage or time since its last replacement. The notifications may also alert the user to check the tires in addition to other vehicle parts depending on the severity of the weather forecast. Other maintenance related notifications may be provided by the system to further help users minimize, avoid or prevent future accidents.

If the user determines that it might be best to change a vehicle component, such as the windshield wipers, then the system may use the electronic map feature to identify the current location of the user and then display location information of the closest maintenance or repair shop. Maintenance or repair shops may register their store information with the system to be included in the digital map. Such store information may include but is not limited to address, hours of operation, phone number, supply stock information, etc. Alternatively, the system's integration with a third-party weather API may also be used to alert the user about weather condition changes and adjustments in the driver's behavior required to help prevent accidents. For example, when there is rain, snow, sleet, or any other type of precipitation that makes driving more difficult and dangerous, the users should be adapting to their environment. These precautionary notifications may ultimately help prevent potential accidents.

In addition to digital maps, the system may utilize statistics to predict future accidents. The statistical analysis of accidents may be carried out periodically at critical locations, which may aid in finding measures to effectively decrease accident rates. The severity of accidents may also be information collected and analyzed zone by zone or location by location, while a length of road may be analyzed by accident density per length of road. These statistical reports are preferably maintained zone-wise, and the location of accidents may be marked on the map so they may be clustered accordingly. By studying the statistics of accidents in specific locations, it may be possible to predict with reasonable accuracy, the probability of future accidents at the location or the threat the location poses to other user types, such as pedestrians. Each zone may be differentiated dynamically by various formats, such as shapes, colors, patterns, etc. Factors such as time of day, and group of risks also help with the differentiation process. For example, users that are classified as a “High-Risk Driver Group” may see a different format such as a “red zone” on computing device 111 when approaching a location, indicating a higher chance of getting into an accident for these users. Conversely, users that are classified as a “Low-Risk Driver Group” may see an “orange zone” when approaching the same location, indicating that the probability of getting into an accident is moderate instead of high. Actuarial parameters that are used to classify users to risk groups include, but are not limited to, age, gender, occupation, education, disability status, height, weight, eyesight condition, city of residence, state of residence, nationality, marital status, accident history, driving record, issuing location of driver's license, credit reports, other risk assessment information, level of education, ethnicity, etc. This type of information holds actuarial significance and may be used for calculating the probability of a user getting into an accident.

Alternatively, the system may utilize different formats such as colors, shading, patterns, etc. to indicate and/or differentiate certain information/data. However, it is to be understood that the use of colors, shading or patterns is not limited, as other formats, such as dots, lines, shapes, pictures, categories, etc., may also be used. For example, an accident at a specific location may be identified by a dot, whereas accident prone streets and blocks are identified by lines and circles. The users may be able to choose their interest zone, whether a specific location, street, or entire block, to see the number of accidents there and that location's relative safety. Different formats such as assorted colors, shading, etc. may be used to indicate accident locations or certain accident related data to show the differences within that data. The assorted colors can be displayed on an electronic map, and/or a display apparatus, and the different formats may be used to identify a possibility of getting into an accident based on the location and category of the user's present location, a density of accidents at specific locations, accident density in both broad and narrow geographic areas, etc. For example, the density may comprise a plurality of locations with higher number of accidents represented by different formats, such as darker colors compared to locations with lesser density of accidents represented by lighter colors. A user's location may also be indicated on the electronic map with a circle surrounding the user's location which moves on the electronic map in correspondence with the user's movements. The circle's color, or different format, may change depending on the volume of accident data and/or risk level available for the route that the user is moving through. However, when the user leaves the area with frequent accident data and/or risk level, the circle surrounding the user's location may disappear to indicate that the high level of risk no longer exists.

A potential user may be asked to register with the service by providing driver's license information which includes his/her name, contact information, mailing and/or billing address, plate information, type of vehicle, the state/country issuing the driver license to create a user ID on the mobile application, etc. More specific information having actuarial significance might be requested from users for data analysis. The user IDs are also necessary for the purposes of tracking and reviewing reports and ratings made by other users. Credit card and/or debit card information may also be requested for subscriber fees or services fees for certain services the mobile application provides for a certified user. Certified users may be allowed to use various features of the mobile application including but not limited to reporting and rating information. The system may include a user profile database configured to store user information and associations between each user and his/her mobile device after registration. Once registered, the users may set and edit their profile information as needed. Settings that may require a user's input or preference may be subsequently changed by the user within the application settings (e.g., on/off). This is also applicable to the type of plate associated with the vehicle.

Since different RRLC may apply differently to non-commercial and commercial vehicles, the users who indicate in their profile that they drive a commercial vehicle may be automatically classified in the category for only commercial vehicle drivers. Non-commercial vehicles may include but are not limited to passenger cars, pick-up trucks, mini-vans, SUVs, etc. Within the commercial vehicles database of the system, the type of commercial vehicle may be split into sub-categories, which may include but are not limited to tractor-trailers, trucks, buses, taxis, limousines, etc. The accident database may include accident data from non-commercial vehicles and commercial vehicles, which might be separately labeled according to the type of vehicles or type of vehicle plates. Vehicle data type may show patterns for different types of vehicles in accidents where those patterns are based on a predetermined number of accidents defined by a user or by the system. Although there are two main types of vehicles that may have their respective databases (i.e., non-commercial and commercial), the two types may be combined and integrated into one database within the system. The users may then be notified about different accidents that occurred at an impact zone and isolated incidents of single accidents. The impact zone may encompass an area which may be within a certain radius or distance of the location with previous accidents, such as a predetermined distance as preset by the user. The settings that the user may preset might affect the size of the impact zone or determine whether a user is to receive a notification alerting him/her to accident prone areas. In this embodiment, the system identifies one or more impact zones comprising one or more regions of a predetermined distance or radius from one or more locations having a predetermined number of traffic accidents previously incurred. The impact zone or zones may then be transmitted to one or more users through a display. The one or more impact zones may be displayed using a first format, while one or more non-impact zones may be displayed using a second format.

The system may allow for reporting of historical and real-time accident information. The mobile application may track certain routes that the user drives through on a more frequent basis and may use this information to notify the user when there are any accidents on that route, which may prepare users before they start traveling. Additionally, the searches performed by the user may also be tracked and saved by the mobile application so that in the future, if there are any new reports of accidents, the user can be notified of these updates. The user may set this function for routes frequently traveled on or for certain routes in their search history. Therefore, this function allows the user to be up-to-date with all reports depending on where they may be traveling to or where they are located.

Another alternative embodiment may include crowdsourcing information about accidents that were reported by users and/or collected by the system administrator. Crowdsourcing is a distributed problem-solving method that utilizes online and offline resources to compile services, ideas, and/or content by the solicitation and/or capturing of data from a variety of people native to a special community targeted. Crowdsourced information may be used in gathering data that is current, updated, and readily available to provide firsthand information through personal knowledge and/or experiences. Crowdsourcing is also effective in gathering information not provided by government data, and may update, supplement and verify or modify the data in database 101 by using information as reported by various users having firsthand experience with a location or collected by the system administrator. The system may use incentives where rewards may be given to encourage user reports to update and supplement the system.

The system may utilize an incentive method for information reporting because database 101 may include crowdsourced data from one or more users through means of UEP 115. Crowdsourcing relies on the participation of many people who are incentivized for participation. Basically, a user who posts and shares accident related information (i.e., preferably including reasons for the occurrence of a previous accident or the presence of any dangerous conditions for a location and/or recommendations for how to avoid potential accidents for the location) that receives a predetermined number of positive ratings may earn one or more rewards. With this method, a user may be rewarded based upon the user's proactive effort to report accident information with efficiency, helpfulness, and accuracy. The system administrator may set the type and/or amount of the reward according to the number of positive ratings received for the provided accident related information. The rewards may encourage users to assist fellow drivers to avoid accidents or even avoid traffic delays related to current accidents. The system of the mobile application may also integrate with a third-party electronic or digital map to provide a street view function in UEP 115 for a better depiction of an accident allowing users to familiarize themselves with the location. In an exemplary embodiment, to earn one or more rewards, the user may be required to be the first user to report, post or share accident related information for a location. Alternatively, to earn one or more rewards the user may be any user supplying additional, different or confirmational accident related information for the location. The user may give the date, the time, beneficial suggestions and/or advice for that location to gain a reward. A user who actively participates to supply crowdsourced information may consent to waive any reward. However, incentives are important for obtaining both an active participation from one or more users to receive traffic accident related data and for obtaining verification of the data. Active participation is important because statistical analysis depends upon a large group of data, and it is important to continuously obtain accident-related data associated with current or updated situations. The searches performed by the user within UEP 115 may be tracked and stored within the application so that for future traveling, the user can be automatically notified of any updates along frequently traveled or favorite routes in their search history.

UEP 115 may provide a rating system to give users an incentive to report, upload credible information and ensure that all reported information is credible. Therefore, reported information may be subject to review and/or ratings by the system administrator and other users. The rating system may be implemented to rate all traffic accident relevant data including, but not limited to, comments, suggestions, reasons for accidents, recommendations for how to avoid accidents, and other thoughts or comments that users input into UEP 115. The users may also report and rate the reasons for accidents and/or recommendations for avoidance of accidents at the location based on their firsthand knowledge. The rating system may list comments from top to bottom according to their number of ratings from most positive to most negative. The reasons and or recommendations with the most positive ratings may be listed and displayed at the top for other users to view. These ratings, reasons, and/or recommendations may also be incorporated into the notifications used to alert other users. The user may be allowed to report to the system administrator any potentially inaccurate information with applicable proof to provide an explanation of the inaccuracies. In response, the system administrator may open a case requesting an employee and/or user to investigate the purported inaccurate information to verify the quality of the information at the location reported. A reward may be provided for the user who may have assisted in the investigation.

Computing system 100 may continuously maintain database 101 of crowdsourced data along with data received from various informational sources, analyzes user reports, detects patterns for locations of possible accidents, and provide real-time alerts to a plurality of users connected to a network, such as a wide-area packet switched network, through computing device 111. Database 101 may comprise information regarding the users and accident causes, which may include but are not limited to excessive speeding and rash or reckless driving, violation of parking and traffic rules, failure to perceive a traffic situation or a traffic control device in an adequate amount of time, carelessness, fatigue, alcohol, sleep etc., vehicle defects such as brake failure, steering system failure, tire failure, lighting system failure, road conditions (i.e., slippery road surface, potholes, ruts, etc.), road design flaws (i.e., defective geometric design like inadequate sight distance, inadequate width of shoulders, improper curve design, improper traffic control devices and improper lighting, etc.), environmental factors (i.e., unfavorable weather conditions like mist, snow, smoke and heavy rainfall, etc.), and other causes. Each input may be assigned a unique tracking number and this unique number may be transmitted to the remote server accompanied by the current position of the user and/or computing device 111.

Since notifications are short and meant to alert the users with quick and easily understandable information about an accident, the user may access UEP 115 function to obtain more comprehensive and detailed information from panel posts which includes but is not limited to inquiries, responses, discussions, pictures, videos, written descriptions, and any other information that may be posted. UEP 115, optionally having a general UEP and a specific UEP, may be used to analyze the reasons for the accidents generally or in certain areas, and help a user to understand accident patterns based on a predetermined number of accidents as defined by a user or by the system.

Computing device 111 may utilize different equipment to communicate with server 102 to receive database information that may be delivered to a user about approaching vehicles, accident patterns, and alerts for future accident prevention. For example, UEP 115 hosts received accident-related data from various users and can be used as a structure within which to implement a monetary or non-monetary rewards allocation system, which may be used as consideration for a user contributing accident related data. The user may utilize the general UEP to access a general discussion area where users can exchange information, make inquiries, provide information on all dangerous locations and traffic rules, as well as share information on avoiding accidents for general locations further comprising highways, streets, and roads. Additional information found in the general UEP may include, but is not limited to, vehicle accident claims, dangerous or defective car products, legal representation, insurance claims, etc. There may also be videos offering instructions on how to drive during various weather conditions, and/or videos on how to safely drive through a railroad crossing.

A user may utilize UEP 115 to report instances of a specific accident. The processing apparatus may communicate with computing system 100 to process information reported from one or more users who input accident related information and upload images of the accident to generate one or more applicable notifications with accident related data corresponding to the identified, designated or present location of the user. Since the user who was involved in an accident may be in the best position to submit suggestions, advice, and/or solutions based on firsthand experience, after being in an accident or obtaining accident information, the user may access the specific UEP to report the location of the accident along with any additional details. The user may identify the type or severity of the accident to be reported from a menu of available pre-determined selections. A multi-level menu system can be used to guide the user to a selection, which identifies the type of accident. The server receives the report and the user's geolocation and determines contextual information that may be provided by the user and/or computing device 111 from the stored user profile to help describe the accident. The processing apparatus may also collect user supplemented information including, but not limited to, personal knowledge and/or firsthand experience with the time of the accident, the exact location, severity of traffic delays, reasons for each accident, etc. Some of the information that a user may be asked to input include photographs, videos, and written explanations to share their thoughts about the accident.

The user or an employee of the system may supplement reported information with photographs of the location and any written explanations in addition to the photographs in the specific UEP that are related to the location of the accident. Due to privacy concerns and the nature of accidents generally, the user who uploads a picture of the accident to database 101 may be given options to protect sensitive information. For example, the application may allow the user to edit the image with an image editing function by covering, blurring, or redacting sensitive information so that users who wish to remain anonymous may do so. A user may cover or blur parts of the image, such as faces, plate numbers, or vehicle identification numbers, etc. Alternatively, if an image needs further clarification, there may be an option to sharpen blurry images to increase the success rate for a computer to recognize the information in the image (e.g., clarification on street names).

The users may access UEP 115 and all its contents from the mobile application regardless of the user's current location while notifications may be displayed when the user is approaching the specific location having previous accidents or at some designated location chosen by the user. The users can access UEP 115 regardless of the user's current location because one of the major goals is to introduce accident related information to the user as early as possible. Information provided by the users in UEP 115 may supplement and update information provided in notifications. The combination of receiving notifications and accessing UEP 115 may provide more useful and extensive information for the users because notifications provide quick, time sensitive information while the panel provides the detailed, extensive information useful to gain full knowledge of the situation.

All functions of the mobile application, such as notifications and UEP 115 may be available in different languages that can be changed by the user. The system may use a third-party service and/or API, or the system administrator may hire professionals to translate the content to different languages or provide explanations in plain English, or alternatively computing system 100 may employ software to automatically translate such content in different languages. The users who utilize this function may record their voice by speaking into computing device 111, which the system may change to a text equivalent within the application. Accordingly, the users may not necessarily have to manually input information and may enter information orally. Both written and oral notifications may be available in a variety of languages and may be changed in the user preferences. The users may also provide translations that are subject to ratings, in exchange for rewards.

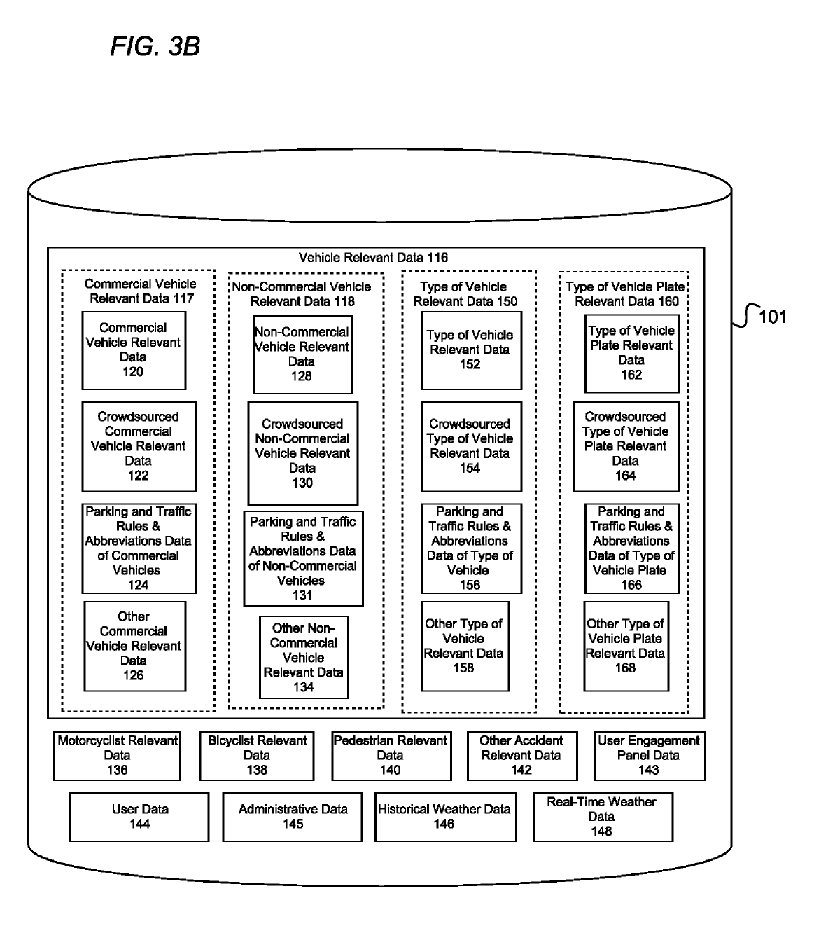

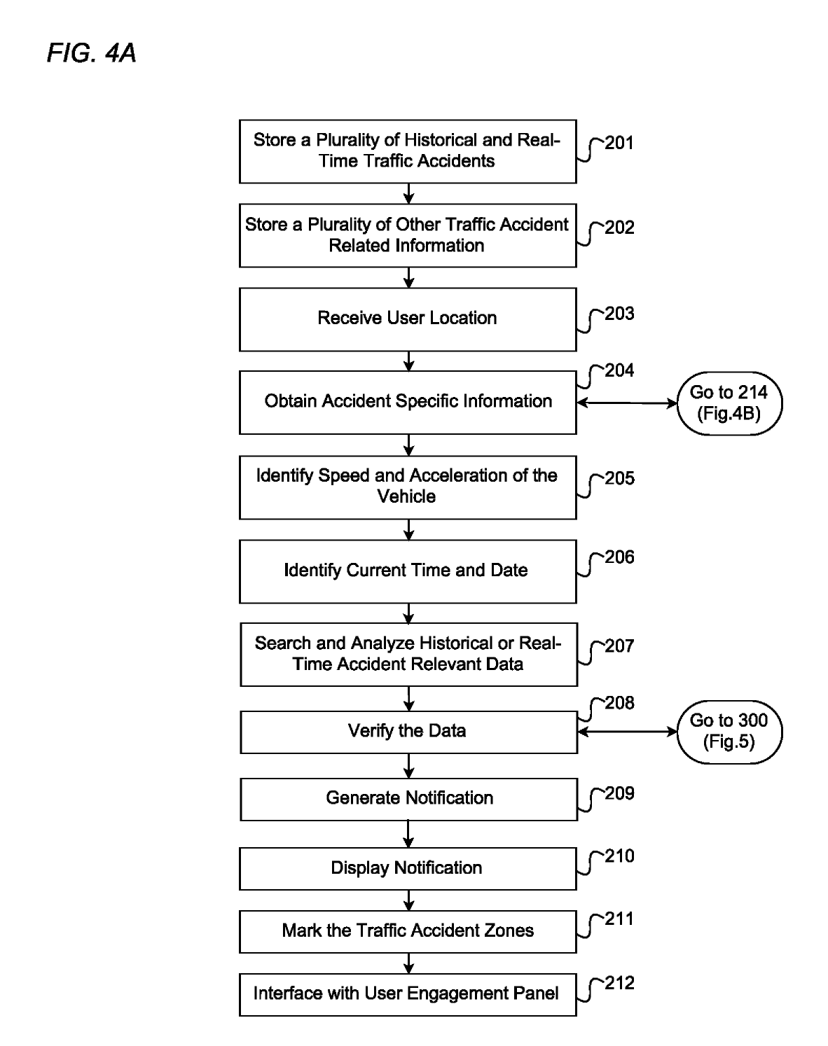

Turning now to FIG. 4A, illustrated is a flowchart showing a method for mapping and storing historical and real-time traffic accident information and alerting a user of the system to the traffic accident information, according to exemplary embodiment of the inventive disclosure, including storing a plurality of historical and real-time traffic accident data for different categories of users in database 101. First, the system stores information or data relating to a plurality of historical or real-time traffic accidents involving, for example, vehicles, motorcyclists, bicyclists, or pedestrians (Step 401). The system and method may also store a plurality of other traffic accident related information (Step 402), which may include reasons, time and location data, category of a person involved in an accident (e.g., user type, age, gender, education, etc.). Preferably, the traffic accident related information or data is stored in a temporary location within database 101 such that the data will not be used in any notifications regarding the related locations until the data is verified, for example, through receiving a predetermined number of positive ratings from additional users. The system then updates database 101 such that the verified data or information may be accessed and used in notifications. Alternatively, the system may accept the traffic accident related data or information and store the data such that it may immediately be used in any relevant notifications, unless and until a predetermined number of negative ratings are received from additional users confirming the inaccuracy of the data or information. The system then updates database 101 to modify or remove the inaccurate information or data. User data, which may include a geocoded location of the user, may be received via, for example, location identifier 112 (Step 403) in order to obtain accident specific information for a location (Step 404) from database 101.

Referencing FIG. 4B, one or more servers 102 may be coupled to a processing apparatus (e.g., CPU 103) to analyze and cross-correlate the time and location of users with the time and location of accidents to alert the user about accident prone locations, according to the user type, by receiving user data and retrieving accident specific information (Step 414) from database 101 and determining a user type of the user (Step 416) from the user data. User types may include but are not limited to vehicle user type, motorcyclist user type, bicyclist user type, or pedestrian user type. The vehicle user type may be further categorized into commercial vehicle user type and non-commercial vehicle user type. The commercial and/or non-commercial vehicle user types may be categorized even further based on type of vehicle or type of vehicle plate. Alternatively, a user may be categorized based on type of vehicle or type of vehicle plate without first being categorized as commercial or non-commercial. Based on user type, the system determines whether the designated location or the location being approached by the user is prone to accidents involving users of this user type, and/or whether it is otherwise dangerous after cross-correlating the user data with the traffic accident related data stored in database 101 based on user type corresponding to data type (Step 418). As a result, users receive notifications about accident prone or otherwise dangerous locations based on at least the data type corresponding to the user type of the user. For example, vehicle relevant data would correspond to at least vehicle user type, where commercial vehicle relevant data would correspond to at least commercial vehicle user type and non-commercial vehicle relevant data would correspond to at least non-commercial vehicle user type. Likewise, motorcyclist relevant data would correspond to at least motorcyclist user type, bicyclist relevant data would correspond to at least bicyclist user type, and pedestrian relevant data would correspond to at least pedestrian user type. Notifications may include data of other data types derived from traffic accidents involving road debris, potholes, animals, etc.

Additionally, notifications for commercial vehicles may be further categorized based on type of vehicle or type of vehicle plate. Thus, a location that is prone to accidents for large commercial vehicles due to their vehicle size, such as a tight corner with improper or inadequate signage for warning drivers, may not be a cause of alarm for a commercial driver of a smaller vehicle. Conversely, an area may be especially dangerous for pedestrians (e.g., locations having wider streets and crossing takes more time compared to other more conventionally sized roads), and any type of vehicle may be a danger to pedestrians crossing the streets. Wider roads may also induce drivers to travel at a higher speed than a narrower road. One of ordinary skill in the art will appreciate that more than one type of data may apply to a user type (i.e., motorcyclist relevant data and vehicle relevant data potentially corresponding to motorcyclist user type). While exemplary embodiments of the inventive disclosure are described herein, they are not intended to limit which user type certain data may have relevancy. One of ordinary skill in the art will appreciate that the inventive disclosure may be configured for alerting only a single user type, for example only bicyclists or only commercial vehicles. In this case, notifications would be generated based on the data type involving bicyclists or commercial vehicles, respectively. Additionally, one of ordinary skill in the art would understand that a user may have an option to be notified about any and all locations where an accident may potentially happen regardless of whether it pertains to the user's user type.

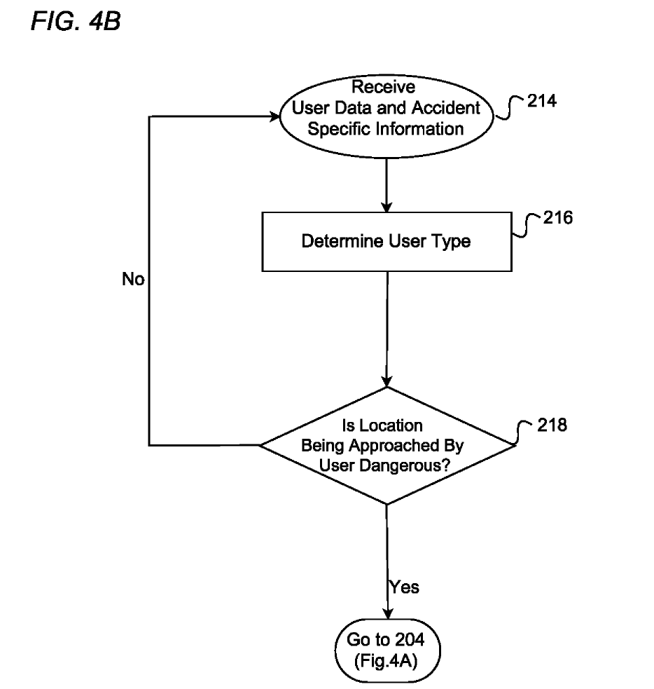

Referring back to FIG. 4A, the method may optionally implement accelerometer/speedometer 238 to identify the vehicle speed and acceleration (Step 405) and clock mechanism 116 to identify current time/date (Step 406). A vehicle's in-vehicle navigation system or computing device 111 may be employed to determine the speed of the vehicle as it approaches a potentially dangerous location and relay that information to computing system 100. The method further searches and analyzes historical or real-time traffic accident relevant data based on the user type (Step 407). Database 101 may then be queried using a location and related history search by computing system 100 by a verification module to verify the searched data (Step 408) as shown in FIG. 5.

Turning to FIG. 5, depicted is a flowchart for a process for data verification for crowdsourced data, according to an exemplary embodiment of the inventive disclosure. By way of example, data verification begins by initiating the verification process or algorithm (Step 500) and identifying firsthand experience of a user who has already received a notification about potential accidents or has passed through or near the location identified to have historical or real-time/recent accidents or otherwise be dangerous (Step 501). The system then retrieves the accident related data from database 101 and verifies the accuracy of the retrieved data by comparing it to the information received from users having firsthand experience about the location (Step 502). Any duplicate accident data may be removed by the system from the received historical and/or real-time data (Step 503) and the data received from database 101 may be modified or supplemented with data acquired through one or more sources different from database 101 (Step 504).

Referring back to FIG. 4A, the system and method may then generate a notification comprising the traffic accident relevant data for the location (Step 409), which may be displayed to a user through remote computing device 111 (Step 410), and the traffic accident zones may be marked (Step 411). Optionally, the traffic accident zones may be marked using different formats such as shapes, lines, patterns, or colors to make it easier for the user to read and understand. The user may interface with UEP 115 (Step 412) to, for example, share ideas, raise questions and get answers and concerns, provide and obtain traffic accident related information comprising reasons, accident prevention methods, etc.

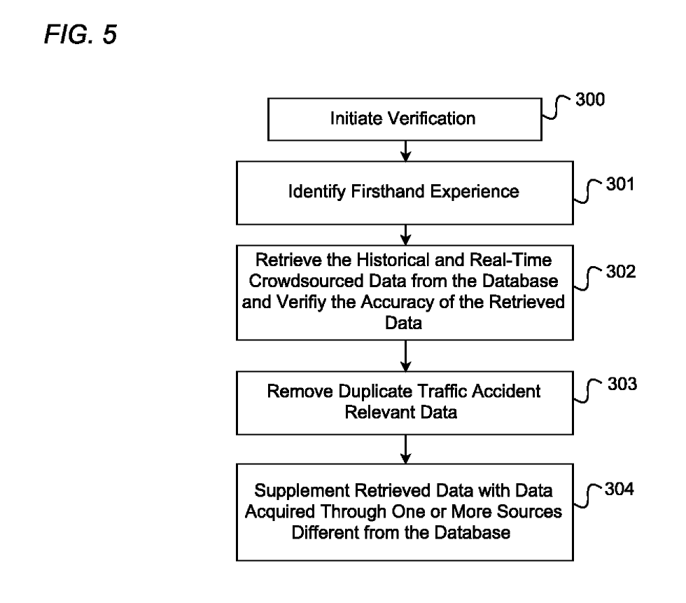

Referring next to FIG. 6, shown is a flowchart illustrating the workflow of an in-vehicle navigation system. When a user begins using an in-vehicle navigation system (Step 601), and enters an intended destination (Step 602), the in-vehicle navigation system begins to navigate the user to the entered destination (Step 603). The in-vehicle navigation system may also be capable of recording and uploading vehicle data (e.g., speed, location, acceleration/deceleration, etc.) (Step 604) to server 102 using, for example, a web portal 114 through a base station and Internet (see FIG. 1). Based on user type, the user's speed and/or location, the system determines if the designated location or the location being approached by the user is prone to accidents or is otherwise dangerous after cross-correlating the user data with the traffic accident related data stored in database 101 based on user type corresponding to data type. If the system detects a potential accident based on the traffic accident relevant data stored in database 101 and the location of the vehicle (Decision 605, Yes), then the system may issue a notification to the user through the user's in-vehicle navigation system or remote computing device 111 to alert the user of prior accidents or other potential dangers (Step 606). The process for issuing a notification to a user for that location may then end (Step 607), though the system may alert the user more than one time, for example, when there is more than one dangerous location along the user's route. If the system does not detect any potential accidents or dangerous locations (Decision 605, No), then the system may continue to monitor the user's speed and location and continue to communicate with database 101 to monitor for potential accidents or dangerous locations. It should also be noted that the steps depicted in FIG. 6 are not intended in any way to foreclose the number of times that a user may receive a notification, which may be fully customizable by the user.

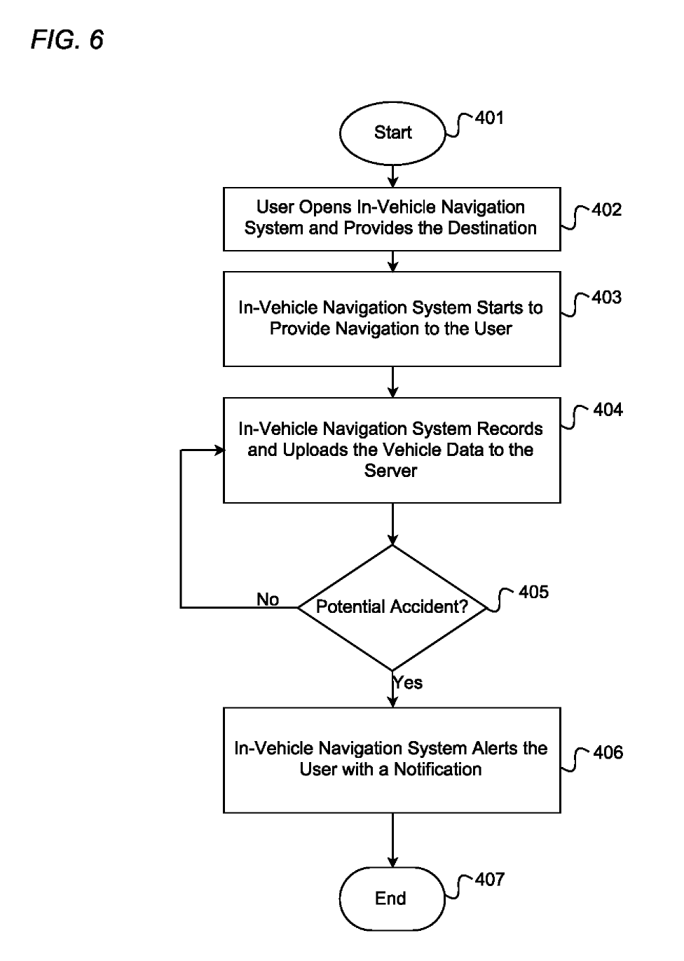

Relevant information stored in database 101 may be updated or otherwise kept current, and FIG. 7 depicts a flowchart that illustrates the workflow of one embodiment of a process by which database 101 may be updated and kept current according to the inventive disclosure. This may involve, in part, one or more users rating submissions through UEP 115. First, a user may submit traffic accident related data using UEP 115 (Step 700), which may be temporarily stored until a predetermined number of additional users rate and validate the information (e.g., using UEP 115, or some other interface). That is, one or more other users can rate this submitted information and based on these ratings the system may be provided with confirmation that the information is accurate or identifying that the information is not accurate by rating the submission positively or negatively, respectively (Decision 701). Negative ratings are noted by the system so that such inaccurate submissions can be flagged and/or corrected. Submissions that are rated positively may remain unchanged or may be clarified with supporting information. If the user rates the submission as inaccurate (e.g., negatively), the user may be prompted to provide proof of the inaccuracy (Step 702). Any confirmed/verified inaccurate accident data may be corrected in database 101 based on the proof that the rating user provides, after the number of negative ratings has reached a predetermined threshold. If, on the other hand, the data in the submission is accurate, then the user's positive rating may be used to reinforce the accident data in database 101. It is through ratings that computing system 100 can determine whether the data is accurate and in fact applicable to a given location for potential accidents. Positive ratings received through UEP 115 are then collected and sorted (Step 703) by computing system 100 to (after the number of positive ratings has reached a predetermined threshold) identify whether to update database 101 or issue an award (Step 705).

Ratings may continue to be collected until the ratings reach a predetermined number (Decision 704), which may be a predetermined number of negative ratings or a predetermined number of positive ratings. If the ratings (positive or negative) reach such a predetermined number (Decision 704, Yes), then database 101 may be modified or updated to reflect the valid or invalid information in the submission (Step 705). If the predetermined number is not reached (Decision 704, No), then the system may continue collecting ratings from users (Step 701). Optionally, the predetermined number of ratings can either be a fixed number (e.g., 10, 25, or 35 ratings or submissions, etc.), or it may be based on a percentage of the total number of ratings (e.g., 25%, 10%, or 1%). The predetermined numbers may also be different based on the traffic volume at a particular location. For example, in a busy location such as a busy intersection, a higher volume of traffic may mean a higher number of users sharing and rating accident information. Alternatively, if the ratings (positive or negative) reach such a predetermined number of positive ratings (Decision 704, Yes), then system 100 may issue an award to the contributing user (Step 705). Also, to better ensure that the submitted data is indeed correct, the system may allow for the notification containing the data submitted through UEP 115 to be rated further before the reward is issued.

UEP 115 may track ratings to keep track of users, so that each accident report is only endorsed once by a user. This will help to prevent abuse of the reward system, which is used to encourage users to provide accurate and timely information, therefore keeping database 101 up-to-date. Other users may be allowed to enter traffic accident information if they believe that the reasons for that same traffic accident differ from the reasons already reported to the system by the first user. UEP 115 may allow a user to take a photograph of the traffic accident, which may be redacted or sharpened before submission. Each location may allow for multiple submissions of one original traffic accident if the reports indicate different reasons. Regardless of location, once the submitted information receives the predetermined number of positive or negative ratings, the information may be used to correct, update, supplement or otherwise modify database 101. Based on updates to database 101 through this process, relevant notifications (e.g., by location, user type, etc.) may then be updated as well by incorporating any updated data into the relevant notification (Step 706).

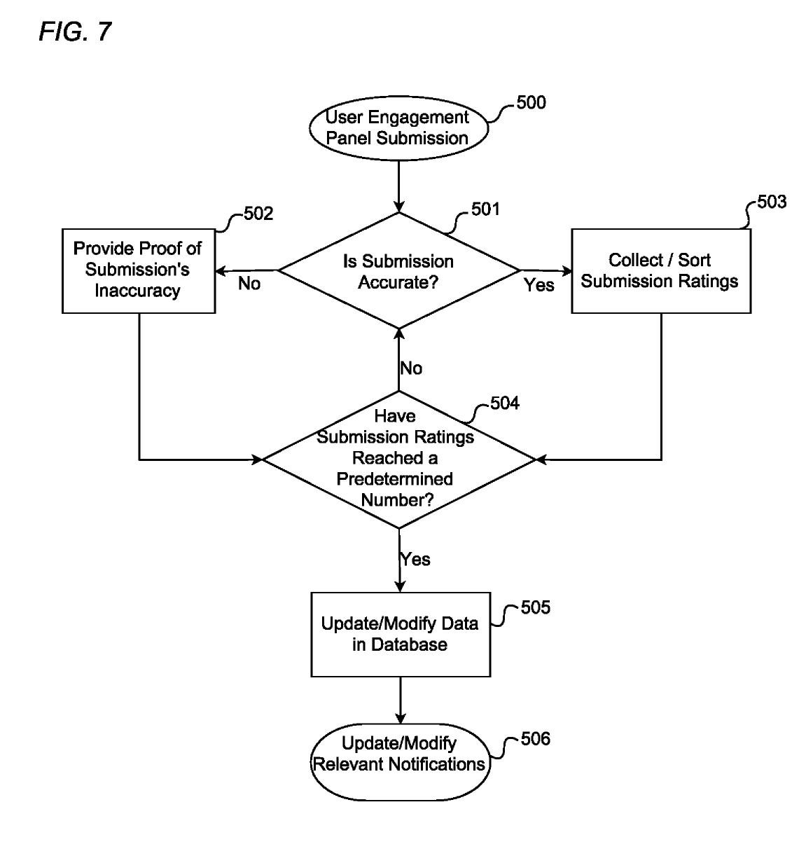

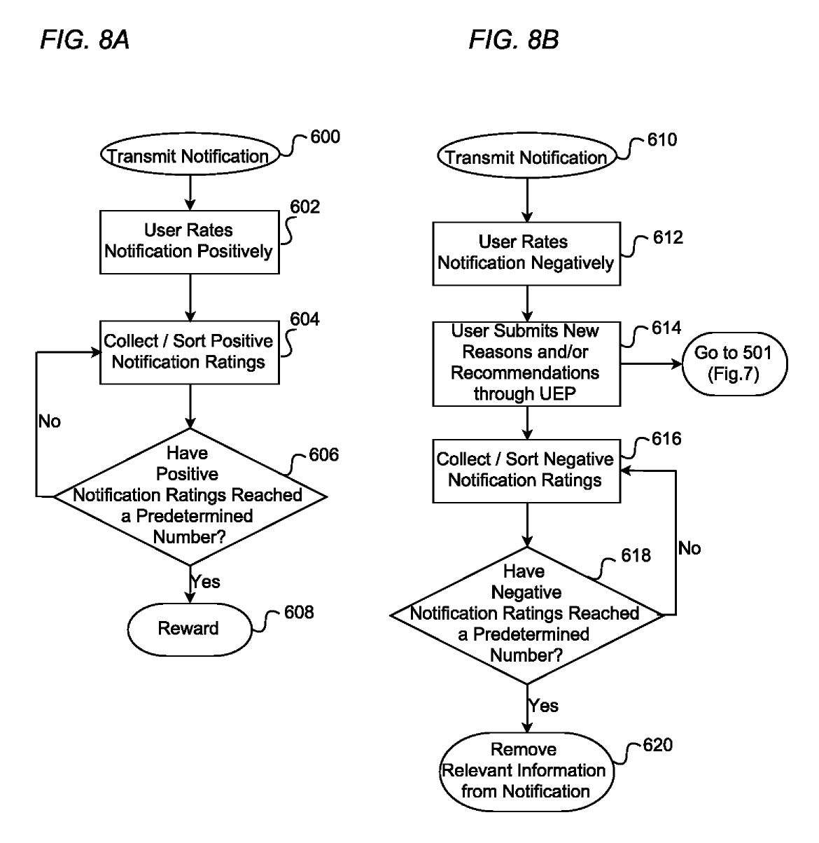

Turning now to FIG. 8A, shown is a flowchart illustrating the workflow of a process by which notifications are rated positively and a reward is issued. As shown, once a notification is transmitted (Step 800) to one or more users, the notification may be subject to ratings by users having firsthand experience with the location being rated. A notification may be in part based on the traffic accident relevant data from an informational source, or it may be in part based on traffic accident relevant data (i.e., preferably including reasons for the occurrence of a previous accident or for any dangerous conditions for a location and/or recommendations for how to avoid potential accidents for the location) from a submission through UEP 115, which has received enough positive ratings to be incorporated into a notification. After having received a notification that the user agrees with, the user may rate the notification positively and provide any relevant comments (Step 802). The system collects and sorts the positive notification ratings (Step 804). Once the number of such positive ratings of the notification reaches a predetermined number (Decision 806, Yes), then an optional award or reward (e.g., monetary or non-monetary), may be issued or provided to the relevant user (Step 808) who is determined to be responsible for the submission of the traffic accident related data that the notification is based on or includes. This way a notification that receives a predetermined number of positive ratings may be reinforced and otherwise kept in place. If the positive ratings have not reached a predetermined number (Decision 806, No), then the system may continue to collect and sort positive ratings (Step 804). Optionally, users rating the data or notification may be issued an award.

Next, FIG. 8B shows a flowchart illustrating the workflow of a potential process by which notifications are rated negatively and database 101 is updated accordingly. After a notification is transmitted (Step 810) and received by a user, the user may rate the notification negatively (Step 812) (i.e., that the reasons and/or recommendations conveyed by such notification were inaccurate either in part or in whole). In this case, the user may provide new reasons, recommendations, and/or any proof (e.g., some officially released data or another type of evidence) of that notification's inaccuracy (Step 814). For example, a user may receive a notification stating that in order to avoid a potential traffic accident, the user should not turn left at a given location. Such a notification may be wrong and the user should actually avoid turning right. Alternatively, whatever condition was present to cause one or more prior accidents may no longer be present or may have changed. As a result, the user may submit a negative rating to such notification because the reasons for traffic accidents at that location are in fact different from those cited in the notification (or no longer apply). The new reasons and/or recommendations are then subject to ratings by additional users through the UEP, according to the process described with respect to FIG. 7. The system may also collect and/or sort the negative ratings (Step 816). Once the number of such negative ratings of the notification for a given location reaches a predetermined number (Decision 818, Yes), information from that notification may be removed in part or in whole depending on whether only part of or the whole notification was rated negatively (Step 820). On the other hand, if the new reasons and/or recommendations submitted by the user (Step 814) receive a predetermined number of positive ratings, as described in FIG. 7 (Decision 704, Yes), the traffic accident relevant data in the database may be updated, corrected, supplemented, or otherwise modified (Step 705) along with any relevant notification (Step 706). If the number of negative ratings for a notification does not reach a predetermined number (Decision 818, No), the system may continue to collect and/or sort the negative ratings (Step 816).

Users having identified firsthand experience may rate the data provided in the notification as a whole. If, however, a user having firsthand experience agrees with part of the data conveyed by the notification but disagrees with another part because the user finds the latter part to be inaccurate, then the user may rate the part he/she agrees with positively and the inaccurate part negatively. In a case where only a part of the data in the notification reaches a predetermined number of positive ratings, the user responsible for submitting that data through UEP 115 in the first place may still receive an award or reward, but such award may only be partial or otherwise limited or reduced. Likewise, if there are more than one contributor of the relevant data, the system may be configured to provide the reward to one contributor (i.e., the first to contribute, the contributor of the most detailed data, etc.) or the system may split the reward between multiple contributors of the relevant data. In a case where an inaccurate part of the notification receives a predetermined number of negative ratings, the data of that part may be removed from database 101 by the system. Additionally, the system administrator may change the type of award or reward and/or amount of reward to different users who report traffic accident information. Also, a user who actively participates in supplying crowdsourced traffic accident related information may do so without expecting to be rewarded. In this case, the user may opt out of receiving rewards through settings in UEP 115 or may simply decline a reward when one is being offered.

Referring next to FIG. 9, shown is an illustration of a potential display of a UEP 115 on computing device 111 in accordance with an exemplary embodiment of the inventive disclosure. UEP 115 can be used to collect (i.e., crowdsource) information and/or data from any of a plurality of users having such computing device 111. All information provided by users through UEP 115 may be subject to ratings through UEP 115 in order to determine its accuracy. Shown in FIG. 9 is an exemplary embodiment of computing device 111, with a display showing an interface of UEP 115. Through UEP 115, the user can access information about specific locations 902, such as information about accidents at the intersection of, for example, Main Street and Northern Boulevard. The user might see instances of accidents and the reasons for accidents 904. Optionally, the user may preset how many reasons/recommendations he/she would like to have displayed for a particular traffic accident location. Through UEP 115, the user can rate the reasons provided either positively or negatively 906 if the user has firsthand experience with the location. To accomplish this, a user may click on, e.g., a “check-mark” for a positive rating or on an “X” for a negative rating. Other symbols or words may also be used.

Firsthand experience may be identified if the user has passed within a predetermined distance of the relevant location or has received a notification relating to the location. For example, a user who has traveled through the intersection at Main Street and Northern Boulevard can rate reasons that have been provided through the system. For example, the “reasons” provided as described herein may additionally or alternatively refer to the reason(s) why a location is dangerous, or why the accident might have happened. Thus, users who are deemed to have “firsthand experience” need not be a direct witness to an accident to provide reasons. In the instance where the system might not have information about (or the reasons for) a certain accident 908, the user may be provided with link 910 to submit a portion or all of the missing information. Optionally, the user may also be provided with link 910 to submit additional information relating to a certain location or traffic accident. Link 910 may be any icon capable of suggesting or otherwise leading a user to a place to enter any missing information about a given location. The user may then be redirected to a different display to enter, for example, a reason for accident 912 if he/she has information pertaining to such accident. If the user would like to submit information, the user might select one or more reasons for an accident from reasons drop-down menu 914. The user can also enter one or more reasons in a free-text field. The reasons provided by users, if they reach a certain predetermined number of positive ratings, might update, correct, supplement, or otherwise modify database 101 accordingly.

Additionally, the user may submit a suggestion through suggestions submission display 916, where the user can enter one or more suggestions 918 on how to best avoid an accident at the particular location. Further, the user may also be able to optionally upload photo 920, video or audio, which may provide further suggestion or advice for the location. The suggestions, reasons, etc. that that user submits through UEP 115 can be subject to ratings from other users. Optionally, the notification may display or include the ratings provided by others, including, for example, the percentage of positive ratings, the percentage of negative ratings, explanations, evidence, etc.

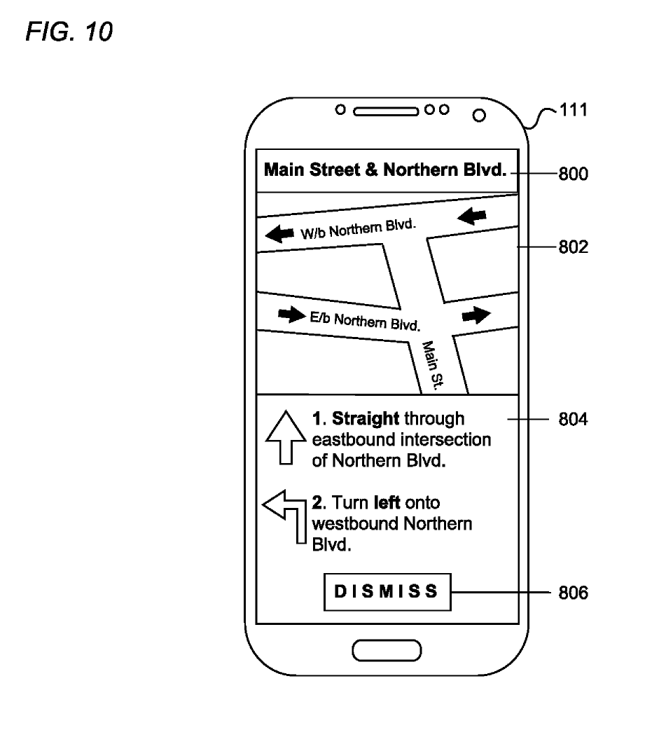

Turning last to FIG. 10, depicted is an illustration showing an exemplary display of a notification that a user may receive on computing device 111. Shown in the display is location 1000, where the location is displayed as an intersection, which can be the user's present or designated location, a location the user is approaching, or a location the user requests to view. For example, the display may indicate that the user is a predetermined distance away (e.g., 20 meters, 50 meters, etc.) from the intersection of Main Street and Northern Boulevard and is to take a left onto westbound (“W/b”) Northern Boulevard. The notification may optionally include electronic or digital map display 1002 of the relevant location and suggestion(s) (or recommendation(s)) 1004 to help the user proceed safely through the intersection.

Recommendation 1004 may be provided as multiple steps (e.g., shown here as two steps). First, the user is advised to proceed straight through the intersection of Main Street past eastbound (“E/b”) Northern Boulevard, which is a one-way portion of the street. Second, the system includes instructions for the user, after proceeding through the intersection and across E/b Northern Boulevard, to turn left onto W/b Northern Boulevard. Recommendation or suggestion 1004 may help prevent the user from taking an immediate left onto E/b Northern Boulevard directly from Main Street, thereby reducing the likelihood he/she may be involved in a traffic accident. Additionally, the display may provide link 1006 for dismissing or otherwise exiting the notification by clicking on the screen, by entering a voice command, by simply proceeding through the intersection, or the notification may disappear on its own after a predetermined time. The user may then be redirected to a ratings page (not shown) in order to rate such notification as accurate or inaccurate or may indicate that a portion of the information included in the notification might be inaccurate. Alternatively, for reasons of safety, the user may be sent, for example, an email having a link to the ratings page so that the user can rate the notification at some later time. Furthermore, the system and method may integrate electronic or digital map 1002 on computing device 111, where the roads/routes may be retrieved from a map database and presented to the user in an understandable manner or format with the analyzed data related to the location and other relevant information.

It is to be understood that the phraseology or terminology employed herein is for the purpose of description and not of limitation. Having described at least one of the preferred embodiments of the inventive disclosure with reference to the accompanying drawings, it is to be understood that such embodiments are merely exemplary and that the invention is not limited to those precise embodiments, and that various changes, modifications, and adaptations may be affected therein by one skilled in the art without departing from the scope or spirit of the invention as defined in the appended claims. Therefore, while the embodiments herein have been described in terms of preferred embodiments, those skilled in the art will recognize that the embodiments herein can be practiced with modification within the spirit and scope of the claims. Any exemplary embodiments described herein are merely illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims. The scope of the invention, therefore, shall be defined solely by the following claims. Further, it will be apparent to those of skill in the art that numerous changes may be made in such details without departing from the spirit and the principles of the invention.

What is claimed is:

1. A computer-implemented system for providing traffic accident avoidance guidance, comprising:
a server communicatively coupled to one or more remote computing devices via a network, wherein the server includes a non-transitory computer-readable storage medium with computer-readable instructions stored therein, a database, and a processor for executing the computer-readable instructions to:
receive traffic accident-related data pertaining to a location;
display, via a user engagement panel of a remote computing device, at least a portion of the traffic accident-related data associated with the location;
receive, from one or more users having firsthand experience with the location, one or more ratings of the portion of the traffic accident-related data displayed, wherein the one or more ratings are positive or negative, wherein the firsthand experience is determined based on the one or more users being within a predetermined distance from the location; and
in response to the one or more positive ratings reaching a predetermined number:
store at least the portion of the traffic accident-related data in the database;
generate a notification based on at least the portion of the traffic-accident related data, wherein the notification comprises data in accordance with a user type; and
transmit the notification to one of the one or more remote computing devices.

2. The system according to claim 1, wherein the notification comprises at least the portion of the traffic accident-related data that was subject to the one or more ratings from the one or more users through the user engagement panel.

3. The system according to claim 1, wherein at least one of the one or more remote computing devices includes a global positioning system (GPS) receiver configured to generate location data corresponding to one or more locations, and wherein determining whether the one or more users were within the predetermined distance from the location is performed by receiving the location data of the one or more remote computing devices corresponding to one or more particular locations of the one or more users.

4. The system according to claim 3, wherein the GPS receiver is located within a mobile device or a vehicle navigation system.

5. The system according to claim 1, wherein the processor further executes the computer-readable instructions to:
predict a potential traffic accident at the location based on at least one of: (i) the portion of the traffic-accident related data stored in the database, (ii) the user type of the one or more users, (iii) one or more traffic accidents having occurred at the location, or (iv) one or more traffic accidents having occurred at a location proximate to the location.

6. The system according to claim 5, wherein the processor further executes the computer-readable instructions to:
display on a graphical user interface of a remote user computing device an electronic map having varying formats depending on a risk of the predicted potential traffic accident at the location, wherein the format comprises at least one of: colors, shading, dots, shapes, patterns, images, lines, or circles, wherein the map identifies at least one of: a specific location, a street, or a block, and wherein the risk is determined based on one of: a time, a time interval, a particular location, a predetermined number of accidents at the particular location and the time interval, or the user type.

7. The system according to claim 5, wherein the predicted potential traffic accident at the location is inferred by cross-correlating a particular location and a designated time with the traffic accident-related data associated with prior traffic accidents at the location during a time frame which includes the designated time.

8. The system according to claim 7, wherein the inference is based on at least one of: (i) the user type corresponding to a data type, (ii) information relating to one or more vehicles involved in an accident at the location, or (iii) information relating to one or more individuals involved in an accident at the location, and wherein the information relating to the one or more individuals involved in the accident at the location comprises at least one of: age, gender, occupation, education, marital status, driving experience, driving history or record, driving vehicles, vehicle operator as a professional driver, travel properties, safety awareness, responsibility and attitude to life, emotional stability, environmental adaptability, adventurous, or psychological demeanor.

9. The system according to claim 1, wherein the traffic accident-related data is stored according to one or more data types comprising at least one of commercial vehicle data type, non-commercial vehicle data type, data type based on vehicle, data type based on vehicle plate, motorcycle data type, bicycle data type, or pedestrian data type, and wherein the user type comprises at least one of: commercial vehicle user type, non-commercial vehicle user type, user type based on vehicle, user type based on vehicle plate, motorcyclist user type, or bicyclist user type.

10. The system according to claim 1, wherein the processor further executes the computer-readable instructions to:
in response to the positive ratings reaching a predetermined number, issue a reward to a contributor of at least a part of the portion of the traffic accident-related data.

11. A computer-implemented system for providing traffic accident avoidance guidance, comprising:
a server communicatively coupled to one or more remote computing devices via a network, wherein the server includes at least one non-transitory computer-readable storage medium with computer-readable instructions stored therein, a database, and a processor for executing the computer-readable instructions to:
receive, from a first remote computing device, traffic accident-related data pertaining to a location, wherein the data includes a reason for a potential traffic accident at the location or a recommendation for avoiding the traffic accident at the location;
receive, from one or more remote additional user computing devices, one or more ratings of at least a portion of the traffic accident-related data, wherein the one or more, ratings are positive or negative;
in response to receiving a predetermined number of the positive ratings or a predetermined number of the negative ratings, update the traffic-accident related data in the database;
receive, from a second remote user computing device, an input comprising the location and a designated time;
identify at least the portion of the traffic accident-related data that is updated in the database and associated with the location; and
transmit to the second remote user computing device at least a portion of the updated traffic accident-related data associated with the location.

12. The system according to claim 11, wherein the processor further executes the computer-readable instructions to:
generate a notification for the location, wherein the notification includes at least the portion of the updated traffic accident related data;
transmit the notification to one or more additional users;
receive, from the one or more remote additional user computing devices, one or more ratings of the notification; and
in response to the notification receiving a predetermined number of positive or negative ratings, update the traffic accident data in the database.

13. The system according to claim 12, wherein the one or more additional users have firsthand experience with the location, and wherein the firsthand experience is determined based on whether (i) the notification associated with the location was received by the one or more additional users, or (ii) the one or more additional users were within a predetermined distance of the location.

14. The system according to claim 13, wherein the one or more additional user remote computing devices include one or more global positioning system (GPS) receivers configured to generate location data corresponding to one or more locations, and wherein the firsthand experience is determined by receiving the location data of a remote computing device corresponding to a particular location of a particular additional user.

15. The system according to claim 14, wherein the GPS receiver is located within a mobile device or a vehicle navigation system.

16. The system according to claim 11, wherein the processor further executes the computer-readable instructions to:
predict a potential traffic accident at the location based on at least one of: (i) at least the portion of the traffic accident-related data retrieved from the database, (ii) a user type of the user, (iii) one or more traffic accidents having occurred at the location, or (iv) one or more traffic accidents having occurred at a location proximate to the location.

17. The system according to claim 16, wherein the predicted potential traffic accident at the location is inferred by cross-correlating a particular location and a designated time with the traffic accident-related data associated with prior traffic accidents at the location during a time frame which includes the designated time.

18. The system according to claim 17, wherein the inference is based on at least one of: (i) the user type corresponding to the data type, (ii) information relating to one or more vehicles involved in an accident at the location, or (iii) information relating to one or more individuals involved in an accident at the location, and wherein the information relating to the one or more individuals involved in the accident at the location comprises at least one of: age, gender, occupation, education, marital status, driving experience, driving history or record, driving vehicles, vehicle operator as a professional driver, travel properties, safety awareness, responsibility and attitude to life, emotional stability, environmental adaptability, adventurous, or psychological demeanor.

19. The system according to claim 11, wherein the traffic accident-related data is stored according to one or more data types comprising at least one of: commercial vehicle data type, non-commercial vehicle data type, data type based on vehicle, data type based on vehicle plate, motorcycle data type, bicycle data type, or pedestrian data type, and wherein the user type comprises at least one of: commercial vehicle user type, non-commercial vehicle user type, user type based on vehicle, user type based on vehicle plate, motorcyclist user type, or bicyclist user type.

20. The system according to claim 11, wherein the processor further executes the computer-readable instructions to:
in response to the notification receiving a predetermined number of ratings, issue a reward to a contributor of at least a part of the reason or the recommendation.
